(19) United States
(12) Patent Application Publication
(10) Pub. No.: US 2025/0125864 A1
(43) Pub. Date: Apr. 17, 2025

(54) SIGNAL MEASUREMENT METHOD AND COMMUNICATION APPARATUS

(71) Applicant: HUAWEI TECHNOLOGIES CO., LTD., Shenzhen, Guangdong (CN)

(72) Inventors: Hejia LUO, Hangzhou (CN); Xian MENG, Hangzhou (CN); Xiaolu WANG, Hangzhou (CN); Yu WANG, Hangzhou (CN); Jun WANG, Hangzhou (CN)

(21) Appl. No.: 19/002,969

(22) Filed: Dec. 27, 2024

Related U.S. Application Data
(63) Continuation of application No. PCT/CN2022/103146, filed on Jun. 30, 2022.

(51) Int. Cl. H04B 7/185; H04B 17/309; H04B 17/318; H04W 24/10

(52) U.S. Cl. CPC H04B 7/18519; H04B 7/18541; H04B 17/328; H04B 17/346; H04W 24/10

(57) ABSTRACT

The disclosure includes a signal measurement method and a communication apparatus. A terminal obtains measurement configuration information, where the measurement configuration information includes information about at least one satellite cell and a measurement time range of the at least one satellite cell, the at least one satellite cell includes a first satellite cell, a measurement time range of the first satellite cell is all or a part of a time length in which a coverage area of the first satellite cell is in a first area, and the first area is an area in which the terminal is located. The terminal measures a signal of the at least one satellite cell in the first area based on the measurement configuration information, to obtain a metric, where the metric indicates a signal quality fluctuation of the at least one satellite cell in the measurement time range.

### CROSS-REFERENCE TO RELATED APPLICATIONS

This application is a continuation of International Application No. PCT/CN2022/103146, filed on Jun. 30, 2022, the disclosure of which is hereby incorporated by reference in its entirety.

### TECHNICAL FIELD

Embodiments of this application relate to the field of communication technologies, and in particular, to a signal measurement method and a communication apparatus.

### BACKGROUND

Currently, 5th generation (5G) new radio (NR) has entered a commercial deployment phase from a standardization phase. The NR standard is researched and designed based on characteristics of terrestrial communication, and has a characteristic of providing high-rate, high-reliability, and low-latency communication for a user terminal. Compared with the terrestrial communication, non-terrestrial network (NTN) communication has characteristics such as a large coverage area and flexible networking. Currently, research institutes, communication organizations, companies, and the like all have participated in research on NTN communication technologies and standards, aiming to build a unified communication network for space-air-ground communication.

In the terrestrial communication, after a radio resource control (RRC) connection is established between the user terminal (user equipment, UE) and a 5G base station (gNodeB, gNB), the gNB delivers measurement control information. When the gNB finds, based on a measurement report periodically reported by the UE, that a target cell meeting a requirement exists, the gNB indicates the UE to hand over to the target cell to receive a service. However, in an NTN communication scenario, if a satellite in an orbit A is close to the UE but is blocked in a given area, communication quality deteriorates. A satellite in an orbit B that covers the same given area may not be affected by blocking. However, based on an existing cell handover mechanism, although a signal of the satellite in the orbit A is blocked at a moment in a communication process, the UE still chooses to receive a communication service of the satellite in the orbit A, resulting in poor service experience of a user. In addition, the UE periodically reports the measurement report, resulting in high overheads.

### SUMMARY

This application provides a signal measurement method and a communication apparatus, to reduce signal measurement overheads, and improve cell handover, cell reselection, and cell access efficiency.

According to a first aspect, this application provides a signal measurement method. The method may be performed by a terminal. The terminal may be understood as UE, a vehicle-mounted device, a chip of the terminal, or the like. A type of the terminal is not specifically limited in this application. The terminal may communicate with a satellite. In this application, the satellite may be a geostationary satellite, a non-geostationary satellite, an artificial satellite, a low earth orbit satellite, a medium earth orbit satellite, a high earth orbit satellite, or the like. This is not specifically limited in this application.

The terminal obtains measurement configuration information, where the measurement configuration information includes information about at least one satellite cell and a measurement time range of the at least one satellite cell, the at least one satellite cell includes a first satellite cell, a measurement time range of the first satellite cell is all or a part of a time length in which a coverage area of the first satellite cell is in a first area, and the first area is an area in which the terminal is located. The terminal measures a signal of the at least one satellite cell in the first area based on the measurement configuration information, to obtain a metric.

In this application, the terminal performs cell signal measurement based on a correlation of coverage of satellites in an orbit or a track and a measurement time range of a satellite in a series in the measurement configuration information, so that a measurement object and a start and end time range are clearly constrained. In this manner, unnecessary handover and reselection can be reduced, thereby reducing signaling exchange, and improving data processing efficiency. In an optional implementation, satellites corresponding to the at least one satellite cell include satellites in a first satellite series and a second satellite series, and satellites in a same satellite series have a same orbit or have a same earth projection track.

In an optional implementation, satellite cells of different satellites in the same satellite series have different measurement start and end time.

In an optional implementation, the measurement configuration information further includes an identifier of a satellite cell and a measurement frequency of the at least one satellite cell.

In an optional implementation, the terminal obtains N signal quality parameters through measurement in the measurement time range of the first satellite cell, and a metric of the first satellite cell includes at least one of the following:
a signal quality parameter of a worst signal in the N signal quality parameters;
a variance of the N signal quality parameters;
a ratio of the variance of the N signal quality parameters to a mean of the signal quality parameters;
a first time length and start and end time of a time period corresponding to a signal quality parameter greater than a first quality parameter threshold in the N signal quality parameters;
a second time length and start and end time of a time period corresponding to a signal quality parameter less than a second quality parameter threshold in the N signal quality parameters;
a ratio of the first time length to the measurement time range of the first satellite cell; and
a ratio of the second time length to the measurement time range of the first satellite cell.

The metric indicates a signal quality fluctuation of the at least one satellite cell in the measurement time range, so that the terminal can be prevented from selecting, only based on short-term signal quality, a satellite that is close to the terminal but may actually be subject to a signal block, to receive a communication service, so that communication quality can be ensured.

In an optional implementation, the signal quality parameter is one of the following:
reference signal received power (RSRP), a received signal strength indicator (RSSI), reference signal received quality (RSRQ), and a signal-to-interference-plus-noise ratio (SINR).

In an optional implementation, the measurement configuration information further includes a report configuration, and the report configuration includes: report content configuration information, indicating a type of the metric included in a measurement report; and a trigger event, indicating a trigger condition for reporting the measurement report.

In an optional implementation, the trigger event includes at least one of the following:
a first trigger event, indicating to report the measurement report when a signal quality fluctuation of a satellite cell in a satellite series of the terminal is greater than a first fluctuation threshold;
a second trigger event, indicating to report the measurement report when the signal quality fluctuation of the satellite cell in the satellite series of the terminal is less than a second fluctuation threshold;
a third trigger event, indicating to report the measurement report when a signal quality fluctuation of a satellite cell in a satellite series other than the satellite series of the terminal is greater than a third fluctuation threshold; and
a fourth trigger event, indicating to report the measurement report when the signal quality fluctuation of the satellite cell in the satellite series other than the satellite series of the terminal is greater than a signal quality fluctuation of a satellite cell in the first satellite series, where
the satellite series of the terminal is a satellite series to which a serving satellite cell of the terminal belongs.

In an optional implementation, the measurement configuration information further includes a measurement condition of a neighboring satellite cell, where the measurement condition of the neighboring satellite cell includes at least one of the following:
a priority of a satellite cell in a satellite series other than a satellite series of the terminal is higher than a priority of a satellite cell in the satellite series of the terminal; and
the priority of the satellite cell in the satellite series other than the satellite series of the terminal is not higher than the priority of the satellite cell in the satellite series of the terminal, and a signal quality fluctuation of the satellite cell in the satellite series of the terminal is greater than a fourth fluctuation threshold, where
the satellite series of the terminal is a satellite series to which a serving satellite cell of the terminal belongs.

In an optional implementation, the measurement configuration information further includes a satellite cell reselection condition, and the reselection condition includes at least one of the following:
in a preset time threshold, signal quality of the satellite cell in the satellite series other than the satellite series of the terminal is not greater than the fourth fluctuation threshold; and
in the preset time threshold, signal quality of the satellite cell in the satellite series other than the satellite series of the terminal is not higher than signal quality of the satellite cell in the satellite series of the terminal.

In an optional implementation, the measurement configuration information further includes: a series identifier of the first satellite series and a series identifier of the second satellite series.

In an optional implementation, a satellite cell of a satellite in the first satellite series forms a hypercell, and a satellite cell of a satellite in the second satellite series forms a hypercell.

In an optional implementation, the terminal receives the measurement configuration information from a network device.

In an optional implementation, if the terminal is in a radio resource control RRC connected state, the terminal reports the metric; or if the terminal is in an RRC non-connected state, the terminal determines whether to start signal measurement in the satellite cell or whether to perform satellite cell reselection.

According to a second aspect, this application provides a signal measurement method. The method may be performed by a network device. The network device may be understood as a satellite, a transmission reception point (TRP), or the like. This is not specifically limited in this application.

The network device determines measurement configuration information, where the measurement configuration information includes information about at least one satellite cell and a measurement time range of the at least one satellite cell, the at least one satellite cell includes a first satellite cell, a measurement time range of the first satellite cell is all or a part of a time length in which a coverage area of the first satellite cell is in a first area, and the first area is an area in which a terminal is located. The network device sends the measurement configuration information.

In an optional implementation, satellites corresponding to the at least one satellite cell include satellites in a first satellite series and a second satellite series, and satellites in a same satellite series have a same orbit or have a same earth projection track.

In an optional implementation, satellite cells of different satellites in the same satellite series have different measurement start and end time.

In an optional implementation, the measurement configuration information further includes a report configuration, and the report configuration includes:
report content configuration information, indicating a type of a metric included in a measurement report; and
a trigger event, indicating a trigger condition for reporting the measurement report.

In an optional implementation, the trigger event includes at least one of the following:
a first trigger event, indicating to report the measurement report when a signal quality fluctuation of a satellite cell in a satellite series of the terminal is greater than a first fluctuation threshold;
a second trigger event, indicating to report the measurement report when the signal quality fluctuation of the satellite cell in the satellite series of the terminal is less than a second fluctuation threshold;
a third trigger event, indicating to report the measurement report when a signal quality fluctuation of a satellite cell in a satellite series other than the satellite series of the terminal is greater than a third fluctuation threshold; and
a fourth trigger event, indicating to report the measurement report when the signal quality fluctuation of the satellite cell in the satellite series other than the satellite series of the terminal is greater than the signal quality fluctuation of the satellite cell in the satellite series of the terminal, where
the satellite series of the terminal is a satellite series to which a serving satellite cell of the terminal belongs.

In an optional implementation, the network device receives the measurement report reported by the terminal based on the measurement configuration information, where the measurement report includes the metric obtained by measuring a signal of the at least one satellite cell in the first area by the terminal based on the measurement configuration information.

The network device makes satellite cell handover decision on the terminal based on the measurement report.

In an optional implementation, the terminal obtains N signal quality parameters through measurement in the measurement time range of the first satellite cell, and a metric of the first satellite cell includes at least one of the following:
a signal quality parameter of a worst signal in the N signal quality parameters;
a variance of the N signal quality parameters;
a ratio of the variance of the N signal quality parameters to a mean of the signal quality parameters;
a first time length and start and end time of a time period corresponding to a signal quality parameter greater than a first quality parameter threshold in the N signal quality parameters;
a second time length and start and end time of a time period corresponding to a signal quality parameter less than a second quality parameter threshold in the N signal quality parameters;
a ratio of the first time length to the measurement time range of the first satellite cell; and
a ratio of the second time length to the measurement time range of the first satellite cell.

In an optional implementation, the signal quality parameter is one of the following: RSRP, an RSSI, RSRQ, and an SINR.

In an optional implementation, the measurement configuration information further includes a measurement condition of a neighboring satellite cell, where
the measurement condition of the neighboring satellite cell includes at least one of the following:
a priority of a satellite cell in a satellite series other than a satellite series of the terminal is higher than a priority of a satellite cell in the satellite series of the terminal; and
the priority of the satellite cell in the satellite series other than the satellite series of the terminal is not higher than the priority of the satellite cell in the satellite series of the terminal, and a signal quality fluctuation of the satellite cell in the satellite series of the terminal is greater than a fourth fluctuation threshold, where
the satellite series of the terminal is a satellite series to which a serving satellite cell of the terminal belongs.

In an optional implementation, the measurement configuration information further includes a satellite cell reselection condition, and the reselection condition includes at least one of the following:
in a preset time threshold, signal quality of the satellite cell in the satellite series other than the satellite series of the terminal is not greater than the fourth fluctuation threshold; and
in the preset time threshold, signal quality of the satellite cell in the satellite series other than the satellite series of the terminal is not higher than signal quality of the satellite cell in the satellite series of the terminal.

In an optional implementation, the measurement configuration information further includes: a series identifier of the first satellite series and a series identifier of the second satellite series.

According to a third aspect, this application provides a communication apparatus. The communication apparatus may be a terminal (for example, the terminal in the first aspect or the terminal in the second aspect) or a chip disposed inside a terminal, or may be a network device (for example, the network device in the first aspect or the network device in the second aspect) or a chip disposed inside a network device. The communication apparatus has a function of implementing any one of the first aspect and the second aspect. For example, the communication apparatus includes a corresponding module, unit, or means for performing the steps in any one of the first aspect and the second aspect. The function, unit, or means may be implemented by software or hardware, or may be implemented by hardware executing corresponding software.

In a possible implementation, the communication apparatus includes a processing unit and a transceiver unit. The transceiver unit may be configured to send and receive signals, to implement communication between the communication apparatus and another apparatus. For example, the transceiver unit is configured to send measurement configuration information. The processing unit may be configured to perform some internal operations of the communication apparatus. The transceiver unit may be referred to as an input/output unit, a communication unit, or the like, and the transceiver unit may be a transceiver. The processing unit may be a processor. When the communication apparatus is a module (for example, a chip) in a communication device, the transceiver unit may be an input/output interface, an input/output circuit, an input/output pin, or the like, and may also be referred to as an interface, a communication interface, an interface circuit, or the like; and the processing unit may be a processor, a processing circuit, a logic circuit, or the like.

In another possible implementation, the communication apparatus includes a processor, and may further include a transceiver. The transceiver is configured to send and receive signals, and the processor executes program instructions, to complete the method in any one of the possible designs or implementations of the first aspect and the second aspect. The communication apparatus may further include one or more memories. The memory is configured to be coupled to the processor, and the memory may store a necessary computer program or necessary instructions for implementing the function in any one of the first aspect and the second aspect. The processor may execute the computer program or instructions stored in the memory. When the computer program or instructions is/are executed, the communication apparatus is enabled to implement the method in any one of the possible designs or implementations of the first aspect and the second aspect.

In still another possible implementation, the communication apparatus includes a processor. The processor may be configured to be coupled to a memory. The memory may store a necessary computer program or necessary instructions for implementing the function in any one of the first aspect and the second aspect. The processor may execute the computer program or instructions stored in the memory. When the computer program or instructions is/are executed, the communication apparatus is enabled to implement the method in any one of the possible designs or implementations of the first aspect and the second aspect.

In yet another possible implementation, the communication apparatus includes a processor and an interface circuit. The processor is configured to communicate with another apparatus through the interface circuit, and perform the method in any one of the possible designs or implementations of the first aspect and the second aspect.

It may be understood that, in the third aspect, the processor may be implemented by hardware or software. When the processor is implemented by hardware, the processor may be a logic circuit, an integrated circuit, or the like. When the processor is implemented by software, the processor may be a general-purpose processor, and is implemented by reading software code stored in a memory. In addition, there may be one or more processors, and one or more memories. The memory may be integrated with the processor, or the memory and the processor are disposed separately. In a specific implementation process, the memory and the processor may be integrated into one chip, or may be disposed on different chips. A type of the memory and a manner in which the memory and the processor are disposed are not limited in embodiments of this application.

According to a fourth aspect, this application provides a communication system. The communication system includes the terminals, the network devices, and the satellites in the first aspect and the second aspect.

According to a fifth aspect, this application provides a chip system. The chip system includes a processor, may further include a memory, and is configured to implement the method in any one of the possible implementations of the first aspect and the second aspect. The chip system may include a chip, or may include a chip and another discrete device.

According to a sixth aspect, this application further provides a computer-readable storage medium. The computer-readable storage medium stores computer-readable instructions. When the computer-readable instructions are run on a computer, the computer is enabled to perform the method in any one of the possible implementations of the first aspect and the second aspect.

According to a seventh aspect, this application provides a computer program product including instructions. When the computer program product runs on a computer, the computer is enabled to perform the method in various embodiments of the first aspect and the second aspect.

For technical effects that can be achieved in the second aspect to the seventh aspect, refer to descriptions of technical effects that can be achieved in the corresponding possible implementation solutions in the first aspect.

### BRIEF DESCRIPTION OF DRAWINGS

FIG. 1 is a diagram of a transparent forwarding architecture according to an example embodiment of this application;

FIG. 2 is a diagram of a regenerative architecture according to an example embodiment of this application;

FIG. 3 is a diagram of a communication scenario according to an example embodiment of this application;

FIG. 4 is a diagram of another communication scenario according to an example embodiment of this application;

FIG. 5A is an example diagram of earth-track-fixed satellites;

FIG. 5B is an example diagram of motion of earth-track-fixed satellites;

FIG. 6 is an example diagram of a communication scenario of a terminal;

FIG. 7 is a schematic flowchart of a signal measurement method according to an example embodiment of this application;

FIG. 8 is an example diagram of a plurality of series of satellites serving a terminal;

FIG. 9A is an example diagram of a satellite series to which conventional orbiting satellites belong;

FIG. 9B is an example diagram of a satellite series to which earth-track-fixed satellites belong;

FIG. 10 is a diagram of a structure of a communication apparatus according to an example embodiment of this application;

FIG. 11 is a diagram of a structure of a communication apparatus according to an example embodiment of this application; and

FIG. 12 is a diagram of a structure of a communication apparatus according to an example embodiment of this application.

### DESCRIPTION OF EMBODIMENTS

To make the objectives, technical solutions, and advantages of this application clearer, the following further describes this application in detail with reference to the accompanying drawings. A specific operation method in a method embodiment is also applicable to an apparatus embodiment or a system embodiment. In the descriptions of this application, unless otherwise specified, “a plurality” of means two or more than two. Therefore, for implementations of apparatuses and methods, refer to each other.

An NTN system may include a satellite system. The satellite system may include a highly elliptical orbit (HEO) satellite, a geostationary (GEO) satellite, a medium earth orbit (MEO) satellite, and a low earth orbit (LEO) satellite based on a satellite altitude, that is, a satellite orbit altitude. In addition, the NTN system may further include an aerial network device such as a high altitude platform station (HAPS) communication system. A network device in this application is not limited to the foregoing example.

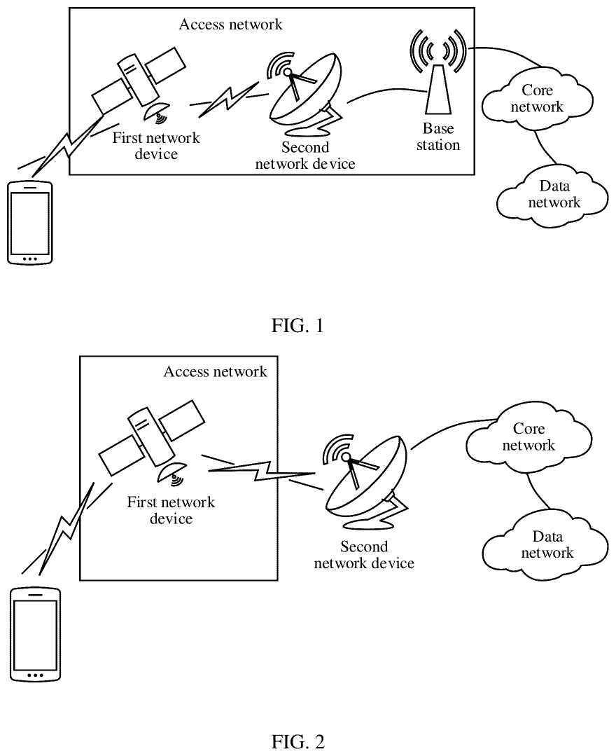

In an example, FIG. 1 is a diagram of an architecture of an NTN network. The NTN network includes a first network device, a second network device, and a terminal. The first network device may be a satellite, for example, may be an HEO satellite, a GEO satellite, an MEO satellite, an LEO satellite, or an HAPS. This is not limited herein. The second network device may be a gateway (also referred to as a terrestrial station, an Earth station, or a gateway station), and may be configured to connect the second network device to a core network. In FIG. 1, a communication mode of the first network device is a transparent transmission mode. To be specific, the first network device is used as a base station for wireless communication. The second network device may be used as a relay of the first network device, and may transparently transmit a signal between the first network device and the terminal. For example, the second network device may access the core network through a base station, to access a data network.

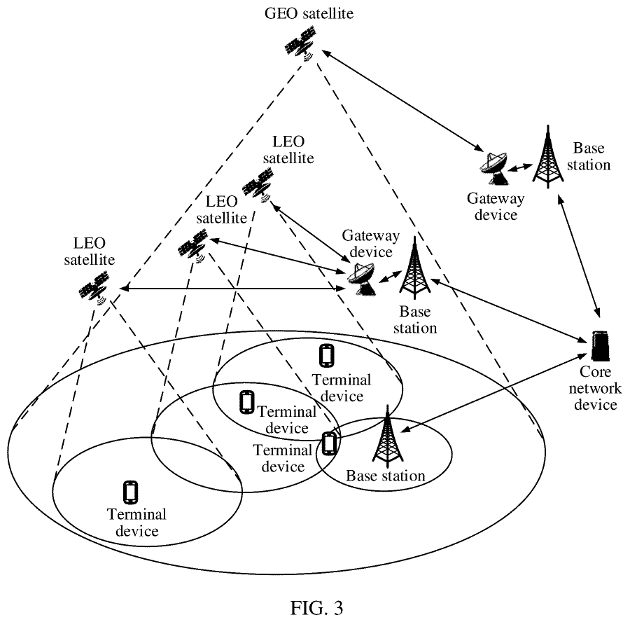

In this embodiment of this application, the communication mode of the first network device may alternatively be a regenerative mode. FIG. 2 is a diagram of another architecture of an NTN network. In FIG. 2, a communication mode of a first network device is a regenerative mode. To be specific, the first network device may be used as a base station for wireless communication. For example, the first network device may be used as a base station, such as an artificial Earth satellite or a high altitude aircraft, for wireless communication. For example, the first network device may be used as an evolved NodeB (eNB) or a gNB. A second network device may transparently transmit signaling between the first network device and a core network.

It should be understood that FIG. 1 and FIG. 2 each show only one first network device and one second network device. In actual use, an architecture with a plurality of first network devices and/or one second network device may be used according to a requirement. Each first network device may provide a service for one or more terminals, each second network device may correspond to one or more first network devices, and each first network device may correspond to one or more second network devices. This is not specifically limited in this application.

An NTN communication system provides seamless coverage for a terminal device by deploying all or some functions of an access network device on an NTN device (for example, a high altitude platform station or a satellite). Because a non-terrestrial device is less affected by a natural disaster, reliability of the communication system can be improved.

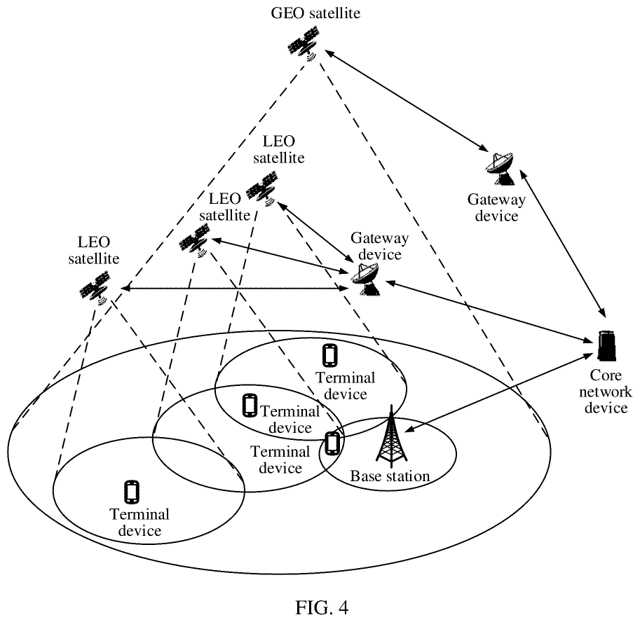

For example, FIG. 3 shows an example of a possible network architecture. In the network architecture shown in FIG. 3, an architecture of an NTN device may be in a transparent transmission mode. FIG. 4 shows an example of another possible network architecture. In the network architecture shown in FIG. 4, an architecture of an NTN device may be in a regenerative mode.

In an example, the NTN device and a terrestrial access network device may be interconnected through a common core network. Alternatively, the NTN device and the terrestrial access network device may implement more timely assistance and interconnection through an interface defined between access network devices. With reference to NR, an interface between access network devices may be referred to as an Xn interface, and an interface between the access network device and the core network may be referred to as an NG interface. The NTN device and the terrestrial access network device may communicate and collaborate with each other through the Xn interface or the NG interface.

Optionally, a link between the NTN device and a terminal device may be referred to as a service link, and a link between the NTN device and a gateway device may be referred to as a feeder link.

A network device may be an NTN device that has all or some functions of an access network device, or may be a terrestrial access network device. The access network device is an entity, for example, a gNB, configured to transmit or receive signals on a network side. The access network device may be a device configured to communicate with a mobile device. The access network device may be an AP in a wireless local area network (WLAN), or may be an eNB in long term evolution (LTE), a relay station, an access point, integrated access and backhaul (IAB), a vehicle-mounted device, a wearable device, an access network device in a future 5G network, an access network device in a future evolved public land mobile network (PLMN), a gNB in an NR system, or the like. In addition, in embodiments of this application, the access network device provides a service for a cell, and the terminal device communicates with the access network device by using a transmission resource (for example, a frequency domain resource or a spectrum resource) used by the cell. The access network device in embodiments of this application may be a central unit (CU) or a distributed unit (DU). Alternatively, the access network device may include a CU and a DU. The CU and the DU may be physically separated, or may be deployed together. This is not specifically limited in embodiments of this application. One CU may be connected to one DU, or a plurality of DUs may share one CU, so that costs can be reduced and network expansion is facilitated. The CU and the DU may be split according to a protocol stack. In a possible manner, an RRC layer, a service data adaptation protocol (SDAP) stack, and a packet data convergence protocol (PDCP) layer are deployed in the CU, and other layers including a radio link control (RLC) layer, a media access control (MAC) layer, and a physical layer are deployed in the DU. The foregoing protocol stack splitting manner is not completely limited in embodiments of this application, and there may be another splitting manner. The CU is connected to the DU through an F1 interface. The CU indicates that a gNB is connected to a core network through an Ng interface. The access network device in embodiments of this application may alternatively be a central unit control plane (CU-CP) node or a central unit user plane (CU-UP) node, or the access network device may include a CU-CP and a CU-UP. The CU-CP is responsible for functions of a control plane, and mainly includes RRC and a PDCP-C. The PDCP-C is mainly responsible for data encryption and decryption, integrity protection, data transmission, and the like on the control plane. The CU-UP is responsible for functions of a user plane, and mainly includes an SDAP and a PDCP-U. The SDAP is mainly responsible for processing data of the core network and mapping a flow to a bearer. The PDCP-U is responsible for encryption and decryption, integrity protection, header compression, sequence number maintenance, data transmission, and the like on the data plane. The CU-CP and the CU-UP are connected through an E1 interface. The CU-CP indicates that a gNB is connected to a core network through an Ng interface. The CU-CP is connected to the DU through F1-C (control plane). The CU-UP is connected to the DU through F1-U (user plane). Certainly, in another possible implementation, the PDCP-C is alternatively in the CU-UP. The access network device mentioned in embodiments of this application may be a device including a CU or a DU, a device including a CU and a DU, or a device including a control plane CU node (a CU-CP node), a user plane CU node (a CU-UP node), and a DU node. In addition, in another possible case, the access network device may be another apparatus that provides a wireless communication function for the terminal device. A specific technology and a specific device form that are used by the access network device are not limited in embodiments of this application. For ease of description, in embodiments of this application, an apparatus that provides a wireless communication function for a terminal device is referred to as an access network device.

The terminal device may be a device capable of receiving scheduling and indication information of the access network device (or the NTN device). The terminal device may be a device that provides voice and/or data connectivity for users, a handheld device having a wireless connection function, or another processing device connected to a wireless modem. The terminal device may communicate with one or more core networks or the Internet through a radio access network (RAN). The terminal device may be a mobile terminal device, such as a mobile phone (also referred to as a “cellular” phone, or a mobile phone), a computer, or a data card, for example, may be a portable, pocket-sized, handheld, computer built-in, or vehicle-mounted mobile apparatus, and exchange language and/or data with the radio access network. For example, the terminal device is a device such as a personal communications service (PCS) telephone, a cordless telephone, a session initiation protocol (SIP) telephone, a wireless local loop (WLL) station, a personal digital assistant (PDA), a tablet computer (Pad), or a computer having a wireless transceiver function. Alternatively, the terminal device may be referred to as a system, a subscriber unit, a subscriber station, a mobile station (MS), a remote station, an access point (AP), a remote terminal device, an access terminal device, a user terminal device, a user agent, a subscriber station (SS), customer premises equipment (CPE), a terminal, UE, a mobile terminal (MT), or the like. Alternatively, the terminal device may be a wearable device or a terminal device in a next-generation communication system, for example, a 5G network, a terminal device in a future evolved PLMN, or a terminal device in an NR communication system. The terminal device may alternatively be a terminal that communicates with the NTN device.

In addition, embodiments of this application are further applicable to another future-oriented communication technology. Network architectures and service scenarios described in this application are intended to describe the technical solutions in this application more clearly, and do not constitute a limitation on the technical solutions provided in this application. A person of ordinary skill in the art may know that: With evolution of network architectures and emergence of new service scenarios, the technical solutions provided in this application are also applicable to similar technical problems.

For ease of understanding of embodiments of this application, the following first briefly describes terms in embodiments of this application.

### (1) Cell Handover/Cell Reselection

It should be noted that cell handover/cell reselection is mainly to ensure that a terminal device receives a service from a cell with good signal quality. However, when the terminal device is in different states, operations of the terminal are different. The following describes cell handover/cell reselection in different cases.

### (1.1) The Terminal Device is in a Connected State.

After an RRC connection is established between UE and a gNB, the gNB delivers related measurement configuration information to configure a measurement behavior of the UE. When the gNB finds, based on a measurement report of the UE, that a target cell meeting a requirement exists, the gNB indicates the UE to perform cell handover. A handover procedure is mainly as follows:

Step 1: The gNB sends the measurement configuration information to the UE by using an RRC reconfiguration (RRCReconfiguration) message.

Step 2: The UE performs cell signal measurement based on the measurement configuration information, to obtain a cell measurement result.

Step 3: The UE reports the measurement result to the gNB by using the measurement report.

Step 4: The gNB determines, based on the measurement report, whether an appropriate new serving cell exists.

Step 5: The gNB determines the new serving cell, and indicates the UE to perform cell handover.

The measurement configuration information includes at least one or more of the following.

Measurement object (measurement object): The measurement object is an object to be measured by the UE, including a synchronization signal/physical broadcast channel block (SSB)/channel state information reference signal (CSI-RS) frequency, an SSB/CSI-RS subcarrier spacing, an SSB-based measurement timing configuration (SMTC), a whitelist cell, or a blacklist cell. In LTE, one measurement object is one separate carrier frequency. In NR, measurement is essentially measurement of a reference signal of a serving cell and a neighboring cell, so that one measurement object is a time-frequency location and a subcarrier spacing of the to-be-measured reference signal. The measurement object in NR indicates information used for SSB-based measurement or CSI-RS-based measurement.

Measurement gap: The measurement gap is a time period for the UE to leave a current frequency and perform measurement on another frequency, and is involved only in inter-frequency measurement and inter-system measurement.

Report configuration: The report configuration includes a criterion for triggering to report a measurement report and a format of the measurement report. Based on types, report configurations are classified into an event-triggered report configuration and a periodic triggered report configuration. The event-triggered report configuration includes various event types and thresholds, duration for which a trigger condition is met, a measurement quantity that needs to be reported, a reference signal type, and the like, as shown in Table 1 below.

TABLE 1

| Event | | | |
|---|---|---|---|
| type | Event definition | Entry condition | Exit condition |
| A1 | Signal quality of a serving | Ms − Hys > Thresh, and the | Ms + Hys < Thresh, and the |
| | cell becomes higher than a | foregoing condition lasts for | foregoing condition lasts for |
| | corresponding threshold | time TimeToTrigger | time TimeToTrigger |
| A2 | Signal quality of a serving | Ms + Hys < Thresh, and the | Ms − Hys > Thresh, and the |
| | cell becomes lower than a | foregoing condition lasts for | foregoing condition lasts for |
| | corresponding threshold | time TimeToTrigger | time TimeToTrigger |
| A3 | Signal quality of a | Mn + Ofn + Ocn − | Mn + Ofn + Ocn + Hys < Ms + Ofs + |
| | neighboring cell is higher | Hys > Ms + Ofs + Ocs + Off, and | Ocs + Off, and the foregoing |
| | than signal quality of a | the foregoing condition lasts | condition lasts for time |
| | serving cell by an offset | for time TimeToTrigger | TimeToTrigger |
| A4 | Signal quality of a | Mn + Ofn + Ocn − Hys > Thresh, | Mn + Ofn + Ocn + Hys < Thresh, |
| | neighboring cell becomes | and the foregoing condition | and the foregoing condition |
| | higher than a | lasts for time TimeToTrigger | lasts for time TimeToTrigger |
| | corresponding threshold | | |
| A5 | Signal quality of a serving | Ms + Hys < Thresh1 and | Ms − Hys > Thresh1 or |
| | cell becomes lower than a | Mn + Ofn + Ocn − Hys > Thresh2, | Mn + Ofn + Ocn + Hys < Thresh2, |
| | threshold 1 and signal | and the foregoing conditions | and the foregoing condition |
| | quality of a neighboring | last for time TimeToTrigger | lasts for time TimeToTrigger |
| | cell becomes higher than a | | |
| | threshold 2 | | |
| . . . | . . . | . . . | . . . |

Related variables in the condition formulas are described as follows:

Ms indicates a measurement result of the serving cell, and Mn indicates a measurement result of the neighboring cell.

Hys indicates a hysteresis of a measurement result.

TimeToTrigger indicates duration, that is, a time lag, for which an entry condition of an event is continuously met.

Thresh, Thresh1, and Thresh2 indicate thresholds.

Ofs and Ofn respectively indicate frequency offsets of the serving cell and the neighboring cell.

Ocs and Ocn respectively indicate cell individual offsets CIOs of the serving cell and the neighboring cell.

Off indicates an offset of a measurement result.

Triggering quantity: The triggering quantity is a policy for triggering event reporting.

Measurement identifier: The measurement identifier combines a measurement object and a report configuration to form a set.

Measurement report reporting manner: The measurement report reporting manner includes event-triggered one-time reporting, event-triggered periodic reporting, and periodic reporting. The event-triggered one-time reporting indicates that, after an entry threshold of a measurement event is met for a period of time (time to trigger), sending of a measurement report is triggered; and after the measurement report is sent once, the procedure ends. The event-triggered periodic reporting indicates that, after an entry threshold of a measurement event is met for a period of time (time to trigger), sending of a measurement report is triggered. After the reporting is triggered, a timer (reportinterval) between a plurality of times of measurement and a counter (reportamount) for a quantity of times of measurement are started. The procedure ends only when a quantity of times of reporting reaches a required value. If the counter is infinite, periodic reporting is performed. The periodic reporting indicates the UE to send measurement reports at a specified report interval (reportinterval).

Triggering amount: The triggering amount is a parameter of the policy for triggering event reporting, and includes one or more of the following.

RSRP: The RSRP indicates received strength of a reference signal.

RSSI: The RSSI indicates total signal strength of a current signal.

RSRQ: The RSRQ indicates a signal-to-noise ratio and an interference level corresponding to current signal quality, and is approximately a ratio of RSRP to an RSSI.

SINR: The SINR indicates a signal-to-interference ratio of a current signal, and is an important indicator for measuring performance of the UE.

In a measurement event used in a handover policy, SSB-based RSRP and SSB-based RSRQ are mainly used as triggering amounts. In other words, the triggering amounts corresponding to the measurement event are RSRP and RSRQ.

RSRP-based triggering: The RSRP-based triggering indicates that measurement triggering and stopping processes are performed based on RSRP. The gNB delivers only RSRP-based event measurement control. The UE performs measurement based on measurement control information. When the UE determines that RSRP of a measurement frequency (or a measured cell) meets an entry condition of a corresponding event, the UE reports a measurement report.

RSRP-and-RSRQ-based triggering: The RSRP-and-RSRQ-based triggering indicates that measurement triggering and stopping processes are performed based on RSRP and RSRQ, and the RSRP-based process and the RSRQ-based process are independent of each other. The gNB simultaneously delivers RSRP-based event measurement control and RSRQ-based event measurement control. The UE performs measurement based on measurement control information. When the UE determines that RSRP or RSRQ of a measurement frequency (or a measured cell) meets an entry condition of an event, the UE reports a measurement report.

RSRP-based triggering and RSRQ-based filtering: The RSRP-based triggering and RSRQ-based filtering indicate that measurement triggering and stopping processes are performed based on RSRP, but a measurement report includes both an RSRP measurement result and an RSRQ measurement result, and neighboring cell filtering is performed based on the RSRQ measurement result. The gNB simultaneously delivers RSRP-based event measurement control and RSRQ-based event measurement control. The UE performs measurement based on measurement control information. When the UE determines that RSRP of a measurement frequency (or a measured cell) meets an entry condition of a corresponding event, the UE reports a measurement report, where the measurement report includes both an RSRP measurement result and an RSRQ measurement result. After receiving the measurement report, the gNB generates a candidate cell list or a candidate frequency list based on the RSRP measurement result, and performs filtering on candidate cells based on the RSRQ measurement result.

In typical aperiodic measurement feedback, the UE measures one or more given reference signals based on measurement configuration information of the gNB; and if it is found that a measurement result meets a trigger condition (for example, is greater than a threshold), the UE triggers a reporting event, and feeds back the measurement result to the gNB. The gNB comprehensively determines, based on the feedback of the UE, whether the UE performs handover or performs corresponding resource scheduling.

### (1.2) The Terminal Device is in a Non-Connected State.

An entire cell reselection procedure includes three phases: starting neighboring cell measurement, reselection evaluation and determining, and cell reselection.

In a procedure similar to that in the connected state, a gNB configures measurement and reselection behaviors of UE. However, the UE in the non-connected state performs measurement based on a different objective. Measurement configuration information includes at least the following content:

### Criterion for Starting Neighboring Cell Measurement:

There is a condition for the UE to start neighboring cell measurement. The UE performs determining on a current serving cell based on the condition, and the UE starts neighboring cell measurement only after the determining passes. This aims to save power for the UE by limiting a measurement action. After starting neighboring cell measurement, the UE calculates R values (variables of an R criterion, which reflect signal quality levels of cells) of the current serving cell and a neighboring cell respectively, and then queues for cell reselection determining. Whether to start neighboring cell measurement is considered mainly based on two factors: a cell reselection priority and signal quality of the current serving cell. For an R value Rₛ of the serving cell and an R value Rₙ of the neighboring cell, refer to related descriptions in 3GPP TS38.304. Details are not further described.

If a priority of the neighboring cell is higher than a priority of the serving cell, the UE starts neighboring cell measurement regardless of the signal quality of the serving cell.

If the priority of the neighboring cell is lower than or equal to the priority of the serving cell, the UE measures the signal quality of the current serving cell, and compares the signal quality of the current serving cell with a signal quality criterion delivered by a network.

If the signal quality of the current serving cell is higher than the signal quality criterion, neighboring cell measurement is not started.

If the signal quality of the current serving cell is lower than or equal to the signal quality criterion, neighboring cell measurement is started.

### Reselection Evaluation and Determining:

After the neighboring cell measurement is completed, the UE starts to evaluate and determine whether to perform cell reselection to a neighboring cell. There may be different determining manners for neighboring cells with different priorities. Using a same priority as an example, reselection for cells with the same priority is performed according to the R criterion: Cell signal quality levels of neighboring cells and a current serving cell are calculated; then, sorting is performed based on the cell signal quality levels, and a cell with a highest cell signal quality level or with a cell signal quality level close to the highest cell signal quality level is selected; and finally, among the cells, a cell that includes a largest quantity of beams with beam signal quality meeting a requirement is selected as a best cell, and it is considered that the cell meets a cell reselection criterion. If the selected best cell continuously meets the cell reselection criterion for TreselectionNR, and the UE camps on the current serving cell for more than Is, the UE starts cell reselection to the neighboring cell.

### Execution of Cell Reselection:

After the neighboring cell measurement is completed and it is determined that a new cell that meets the cell reselection condition exists, the UE starts to attempt to camp on the new cell. The UE searches for a target cell. The UE receives a system message of the target cell. If there is no access restriction (for example, the UE determines, based on the system message of the target cell, whether the target cell is barred (barred) or reserved (reserved)), the UE camps on the target cell, that is, performs reselection to the target cell. Otherwise, the UE still camps on the current serving cell.

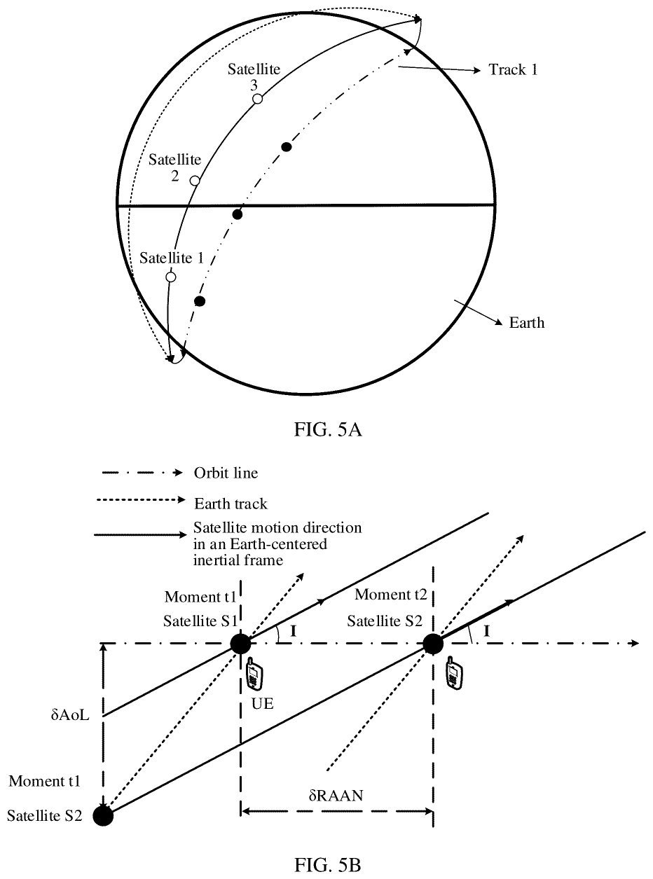

(2) earth-track-fixed satellite link: The earth-track-fixed satellite link includes a group of satellites that have a same orbital inclination, but are in discrete orbits and have a same earth projection track. For example, as shown in FIG. 5A, a satellite 1, a satellite 2, and a satellite 3 form a group of satellites that have a same orbital inclination, and earth projection tracks thereof are a track 1. To ensure that all the satellites on the earth-track-fixed satellite link have the same earth projection track, in addition to a case in which all the satellites on the satellite link need to have the same orbital inclination, any two satellites have a same proportion of a right ascension of the ascending node (right ascension of the ascending node, RAAN) difference (the right ascension of the ascending node difference, where an ascending node is a point at which a satellite crosses the equator from the southern hemisphere to the northern hemisphere) to an argument of latitude (AoL) difference (where the argument of latitude difference indicates an angular distance between any location of a planet or a satellite in an orbit thereof and the ascending node), and the proportion can compensate for a longitude drift caused by Earth's rotation and an orbital perturbation, that is, the following formula can be satisfied:

$$\frac{{ω}_{E} - \dot{Ω}}{{n}_{0} + {\dot{M}}_{0} + \dot{ω}} = \frac{δ RAAN}{δ AoL} .$$

ω_{E} is an angular velocity of Earth's rotation, and no is an angular velocity of motion of a satellite; \dot{Ω} is an orbital perturbation of the right ascension of the ascending node; \dot{M}₀ is an orbital perturbation of a mean anomaly; \dot{ω} is an orbital perturbation of an argument of periapsis; and δRAAN is the right ascension of the ascending node difference between orbits of the satellites, and δAoL is the argument of latitude difference between the satellites.

As shown in FIG. 5B below, a satellite S1 and a satellite S2 are two satellites on the earth-track-fixed satellite link, the satellite S1 and the satellite S2 are both in independent orbits, and orbital inclinations I are the same. At a moment t1, the satellite S1 passes through the equator from south to north, an earth projection of the satellite S1 falls within UE, and the satellite S2 is located on a south side of the equator and a west side of S1. Due to Earth's rotation, at a moment t2, the satellite S2 also passes through a same point on the equator, and an earth projection of the satellite S2 also falls within the UE (assuming that the UE is stationary relative to the Earth). Although the satellite S1 and the satellite S2 run in different orbits, the satellite S1 and the satellite S2 have a same earth motion track.

(3) earth-track-fixed constellation: The earth-track-fixed constellation is a constellation including one or more earth-track-fixed satellite links.

(4) Conventional satellite orbit and satellites therein: Different satellites in a same orbit have a same altitude, RAAN, and orbital inclination, but locations of the satellites in the orbit are different at a given reference moment.

(5) Hypercell: In an existing terrestrial communication network, a plurality of base stations in a tunnel or a high-speed railway are usually considered as a plurality of TRPs in one cell, and the plurality of TRPs are configured as one logical cell. The TRPs use a same physical cell identifier (PCI), cell global identifier (CGI), frequency, and bandwidth. Because the TRPs use the same PCI and CGI, and the UE cannot sense existence of the plurality of TRPs when moving between the TRPs, cell handover is not required.

There are a plurality of different implementations for the hypercell, and a fundamental objective is to reduce overheads for handover between different TRPs in the hypercell, and improve performance of the UE at an edge of a coverage area. A typical implementation for the hypercell is as follows:

The TRPs use the same PCI, CGI, frequency, and bandwidth. Because the TRPs use the same PCI and CGI, and the UE cannot sense existence of the plurality of TRPs when moving between the TRPs, cell handover is not required.

It should be noted that the existing method in which the terminal device in the connected state performs cell handover may be further used in an NTN system.

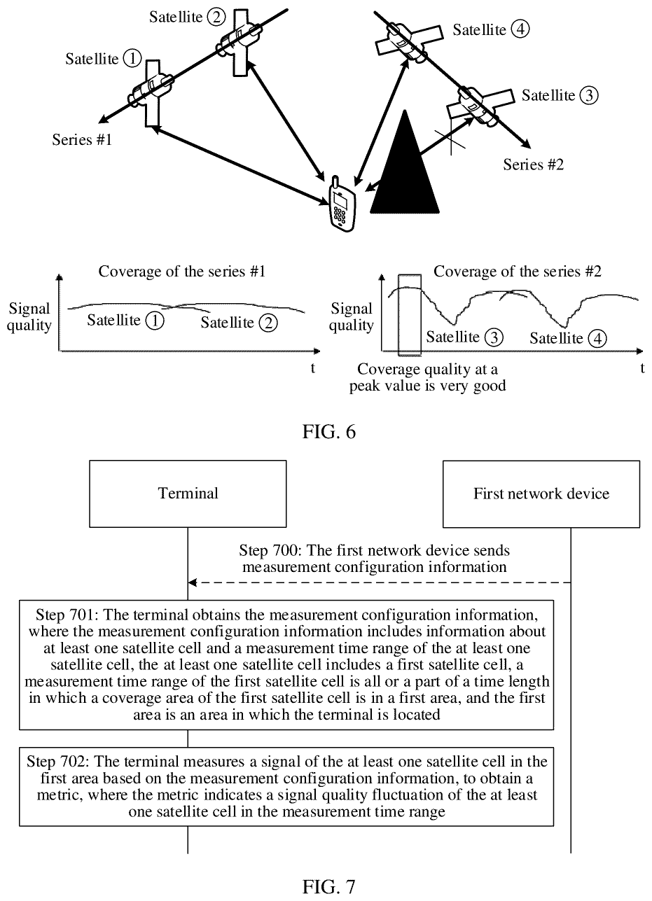

However, for a scenario such as satellite communication, determining based on a relatively short-term or short-term measurement result is not necessarily intended to select an appropriate serving cell (that is, a cell in coverage of a satellite) in a longer period of time. In a scenario shown in FIG. 6, UE may transmit data with satellites in two different orbits. Satellites in each orbit may be considered as a satellite series, and the satellites move along an arrow direction and sequentially cover the UE. Satellites in a series #2 are closer to the UE than satellites in a series #1. However, blocking exists between a satellite 3 and the UE due to the terrain.

Because the satellites in the series #2 are closer to the UE, coverage quality of the satellites in the series #2 in a time slice is better. However, signals sharply deteriorate due to the blocking. Signals sensed by the UE change with time, as shown in FIG. 6. Signals that are of the satellites in the series #1 in the time slice and that are sensed by the UE change with time, as shown in FIG. 6.

In a short period of time, it is more appropriate for the UE to connect to or camp on a satellite in the series #2. However, when the UE needs to connect to or camp on a satellite in another orbit in a period of time, signal interruption and other signaling overheads are caused. Therefore, in a long period of time, it is more appropriate to keep the UE connected to a satellite in the series #1. However, an existing measurement reporting mechanism lacks measurement and reporting at a long-time granularity. Therefore, the UE still chooses to connect to or camp on the satellite in the series #2, and a characteristic of strong predictability in the foregoing satellite scenario cannot be effectively used. As a result, user experience is poor, and there is no targeted configuration for satellite coverage in a measurement reporting time range. In addition, based on the periodic triggered report configuration, long-term signal quality may be obtained, but frequent reporting overheads are very high. For long-term reporting for which only a measurement statistical feature needs to be obtained, frequent reporting causes excessively high overheads.

When the existing method in which the terminal device in the non-connected state performs cell reselection is applied to the NTN system, in a current reselection mechanism, a mechanism of performing optimal determining by using information about coverage of a previous satellite is lacked, and determining is easily performed based on only short-term measurement, resulting in unnecessary repeated reselection.

In consideration of the foregoing cases, this application provides a signal measurement method, to reduce unnecessary handover and reselection when a measurement object and a start and end time range are clearly constrained. In this way, when signaling overheads are reduced and communication quality of signals is ensured, the signal measurement method is applied to cell handover, reselection, and access scenarios. In the following descriptions, an example in which the method is applied to the communication architectures shown in FIG. 1 and FIG. 2 is used. Data exchange between a terminal and a first network device (for example, the first network device in FIG. 1 and FIG. 2, which may also be referred to as a satellite base station) may be used as an example for description. It should be noted that communication systems in FIG. 1 and FIG. 2 are merely used as examples in embodiments of this application. A scenario is not limited thereto. In FIG. 7, data exchange between a terminal and a first network device is used as an example for description.

Step 701: The terminal obtains measurement configuration information, where the measurement configuration information includes information about at least one satellite cell and a measurement time range of the at least one satellite cell, the at least one satellite cell includes a first satellite cell, a measurement time range of the first satellite cell is all or a part of a time length in which a coverage area of the first satellite cell is in a first area, and the first area is an area in which the terminal is located.

It should be noted that the measurement configuration information may be from the first network device. If the terminal has accessed a network, the first network device may obtain location information of the terminal, and may know satellites that can cover the area in which the terminal is located. In this case, the first network device may send information about satellite cells and measurement time ranges of the satellite cells to the terminal, so that the terminal measures signals of the satellite cells. Certainly, there is also a case in which the terminal does not access the network. There may be a plurality of first network devices that may deliver, by using a reference signal, information about satellite cells served by the first network devices and measurement time ranges of the satellite cells. If the terminal can receive the reference signal, the terminal may obtain the measurement configuration information.

Optionally, before step 701 is performed, step 700 may be performed: The first network device sends the measurement configuration information.

In addition, it should be further noted that the area in which the terminal is located may be covered by a plurality of satellite cells. Therefore, the measurement configuration information may include information about the plurality of satellite cells, and information about different satellite cells may be indicated by using different cell identifiers, such as PCIs and CGIs.

Because a location of the terminal and a location of a satellite may constantly change, the measurement configuration information may be periodically updated, for example, updated every day or updated every 10 hours; or may be triggered to be updated based on the change of the location of the terminal. For example, measurement configuration information obtained by the terminal at a location 1 (located in the southern hemisphere) is different from measurement configuration information obtained by the terminal at a location 2 (located in the northern hemisphere). This is not specifically limited in this application.

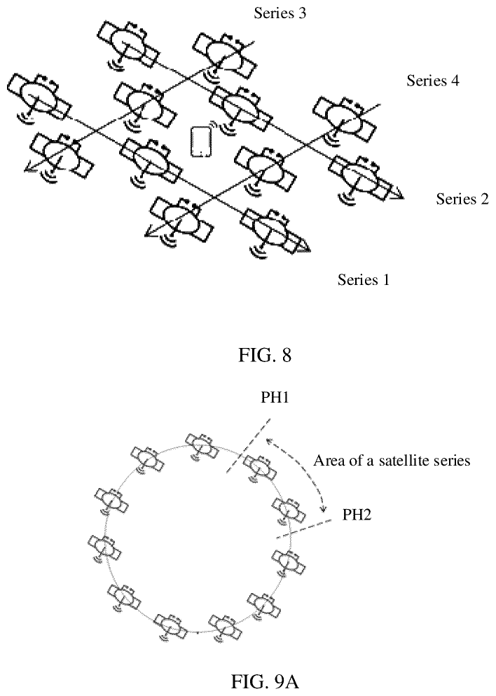

Optionally, satellites corresponding to the at least one satellite cell include satellites in a first satellite series and a second satellite series, and satellites in a same satellite series have a same orbit (that is, are located in a same orbit) or have a same earth projection track (that is, are satellites on an earth-track-fixed satellite link). In addition, the measurement configuration information may further include a series identifier of the first satellite series and a series identifier of the second satellite series. As shown in FIG. 8, there are four series of satellites around the terminal, and the measurement configuration information includes information about satellite cells in the four series and measurement time ranges of the satellite cells in the four series. The terminal needs to measure signal quality of the satellite cells in the four series.

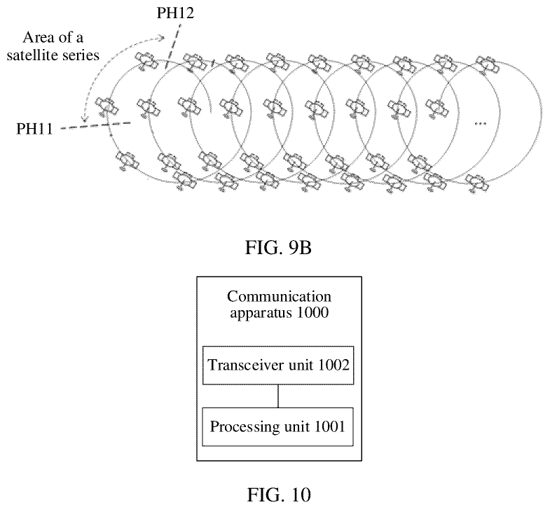

For conventional orbiting satellites, that is, satellites in a same orbit, a plurality of series of satellites that are visible to the terminal are shown in FIG. 8. For example, an orbit in which a satellite is located may be determined by using information (including an altitude, an inclination, and an angle of an ascending node) about the orbit in which satellites in each series are located, and then a range in the orbit may be described by using an angle offset range relative to a reference point agreed in the orbit (for example, an opening angle between a location of the current satellite and the ascending node relative to the center of the earth). As shown in FIG. 9A, an area in which satellites in a series are located is an area between PH1 and PH2.

As shown in Table 2 below, repeated information such as altitude information and an inclination of an orbit is omitted (if information is different, the information cannot be omitted). The first network device may notify the terminal of satellite ephemeris information in a large range, and then notify the terminal of a selection criterion for the satellites in the series. The terminal may calculate, at given time, a real-time location of a satellite in an orbit corresponding to the series, and then perform comparison to determine whether the satellite is located in a specific area required by the satellites in the series. If the satellite is located in the specific area required by the satellites in the series, it indicates that the satellite belongs to the specific satellite series. A right ascension of the ascending node of a satellite series 1 is RAAN1, an area in which the satellite series 1 is located is [PH11, PH12], and a measurement time range of a satellite cell in the satellite series 1 is t1s (measurement start time) to t1e (measurement end time).

TABLE 2

| Satellite | Right ascension of | Angle offset relative | Measurement |
|---|---|---|---|
| series | the ascending node | to a reference point | time range |
| 11 | RAAN1 | [PH11, PH12] | t1s-t1e |
| 12 | RAAN2 | [PH21, PH22] | t2s-t2e |
| . . . | . . . | . . . | . . . |

It should be noted that Table 2 is described for the conventional orbiting satellites. However, different satellite series may include a plurality of satellites, and different satellite cells may be indicated by using different cell identifiers, such as PCIs and CGIs. In addition, different satellite cells in a same series have different measurement start and end time, and measurement frequencies corresponding to different satellite cells may be the same or different. For example, measurement frequencies of neighboring satellite cells are different, and measurement frequencies of non-neighboring satellite cells may be configured to be the same. The measurement configuration information may be shown in Table 3 below. It is assumed that the satellite series 1 is a satellite series currently serving the terminal, the satellite series includes a plurality of satellite cells, and different satellite cells are indicated by using different PCIs. For example, a PCI is ID #1a, a measurement time range of a satellite cell is t1a-s (measurement start time) to t1a-e (measurement end time), and a measurement frequency is 1a for an SCS1a. An example is only used for description herein, and an identifier, a measurement time range, and a measurement frequency of a satellite cell are not specifically limited. Certainly, in actual application, the measurement configuration information may also include other information, which is not shown one by one herein.

TABLE 3

| Satellite | Identifier of a | Measurement | Measurement |
|---|---|---|---|
| series | satellite cell | time range | frequency |
| 1 | ID#1a | t1a-s-t1a-e | Frequency 1a: SCS1a |
| | ID#1b | t1b-s-t1b-e | Frequency 1b: SCS1b |
| | ID#1c | t1c-s-t1c-e | Frequency 1c: SCS1c |
| | . . . | . . . | . . . |
| 2 | ID#2a | t2a-s-t2a-e | Frequency 2a: SCS2a |
| | ID#2b | t2b-s-t2b-e | Frequency 2b: SCS2b |
| | ID#2c | t2c-s-t2c-e | Frequency 2c: SCS2c |
| | . . . | . . . | . . . |
| . . . | . . . | . . . | . . . |

For satellites having a same earth projection track, for example, an orbit in which a satellite is located may be determined by using information (including an altitude, an inclination, a start RAAN, and a start AoL) about the orbit in which satellites in each series are located, and then a range in the orbit may be described by using an offset range relative to a reference point agreed in the orbit (for example, an intersection of the orbit and the equator, or the start RAAN and the start AoL). As shown in FIG. 9B, an area in which satellites in a series are located is an area between PH11 and PH12.

As shown in Table 4 below, repeated information such as altitude information and an inclination of an orbit is omitted (if information is different, the information cannot be omitted). The first network device may notify the terminal of satellite ephemeris information in a large range, and then notify the terminal of a selection criterion for the satellites in the series. The terminal may calculate, at given time, a real-time location of a satellite in an orbit corresponding to the series, and then perform comparison to determine whether the satellite is located in a specific area required by the satellites in the series. If the satellite is located in the specific area required by the satellites in the series, it indicates that the satellite belongs to the specific satellite series. A start RAAN of a satellite series 2 is RAAN1, a start AoL of the satellite series 2 is an AoL1, an area in which the satellite series 2 is located is [PH21, PH22], and a measurement time range of a satellite cell in the satellite series 2 is t2s (measurement start time) to t2e (measurement end time).

TABLE 4

| Satellite | Start RAAN | Angle offset relative | Measurement |
|---|---|---|---|
| series | and start AoL | to a reference point | time range |
| 1 | RAAN1 and AoL1 | [PH11, PH12] | t1s-t1e |
| 2 | | [PH21, PH22] | t2s-t2e |
| 3 | RAAN2 and AoL2 | [PH31, PH32] | t3s-t3e |
| 4 | | [PH41, PH42] | t4s-t4e |
| . . . | . . . | . . . | . . . |

It should be noted that Table 4 is described for satellites on an earth-track-fixed satellite link. However, different satellite series may include a plurality of satellites, and different satellite cells may be indicated by using different cell identifiers, such as PCIs and CGIs. In addition, different satellite cells in a same series have different measurement start and end time, and measurement frequencies corresponding to different satellite cells may be the same or different. For example, measurement frequencies of neighboring satellite cells are different, and measurement frequencies of non-neighboring satellite cells may be configured to be the same. The measurement configuration information may be shown in Table 5 below. It is assumed that a satellite series 1 is a satellite series currently serving the terminal, the satellite series includes a plurality of satellite cells, and different satellite cells are indicated by using different PCIs. For example, a PCI is ID #1a, a measurement time range of the satellite cell is t1a-s (measurement start time) to t1a-e (measurement end time), and a measurement frequency is a frequency 1 for an SCS1. An example is only used for description herein, and an identifier, a measurement time range, and a measurement frequency of a satellite cell are not specifically limited.

TABLE 5

| Satellite | Identifier of a | Measurement | Measurement |
|---|---|---|---|
| series | satellite cell | time range | frequency |
| 1 | ID#1a | t1a-s-t1a-e | Frequency 1a: SCS1a |
| | ID#1b | t1b-s + Δ-t1b-e + Δ | Frequency 1b: SCS1b |
| | ID#1c | t1c-s + 2Δ-t1c-e + 2Δ | Frequency 1c: SCS1c |
| | . . . | . . . | |
| 2 | ID#2a | t2a-s-t2a-e | Frequency 2a: SCS2a |
| | ID#2b | t2b-s + δ-t2b-e + δ | Frequency 2b: SCS2b |
| | ID#2c | t2c-s + 2δ-t2c-e + 2δ | Frequency 2c: SCS2c |
| | . . . | . . . | |
| . . . | . . . | . . . | . . . |

In Table 3, time offsets of measurement time ranges of satellite cells are configured to be the same, so that instruction overheads can be reduced. To avoid a loss of generality, in Table 5, the time offsets of the measurement time ranges of the satellite cells are configured to be represented by using Δ and δ. Δ and δ may be the same or different. This is not specifically limited in this application.

Step 702: The terminal measures a signal of the at least one satellite cell in the first area based on the measurement configuration information, to obtain a metric, where the metric indicates a signal quality fluctuation of the at least one satellite cell in the measurement time range. Optionally, the metric includes a metric of the first satellite series and a metric of the second satellite series. Generally, the terminal measures metrics of a satellite cell of a satellite in the first satellite series and a satellite cell of a satellite in the second satellite series. Certainly, in actual application, when the measurement configuration information includes a plurality of satellite series, the terminal measures signals of satellite cells in the plurality of satellite series based on the measurement configuration information of the plurality of satellite series, and then compares metrics of different satellite series to determine a satellite cell in which a satellite series has a larger signal quality fluctuation. Because the metrics of the different satellite series are similar, the terminal obtains only N signal quality parameters through measurement in the measurement time range of the first satellite cell, and a metric of the first satellite cell includes at least one of the following.

### Metric 1: Signal Quality Parameter of a Worst Signal in the N Signal Quality Parameters

It should be noted that a signal quality parameter is generally indicated by using one of the following: RSRP, an RSSI, RSRQ, and an SINR; or by using a variation of the foregoing several parameters, for example, the triggering amount, or RSRP-based triggering and RSRQ-based filtering described in (1.1). This is not specifically limited in this application.

In actual application, one satellite may cover a plurality of satellite cells. In this specification, brief descriptions are provided herein, and an example in which one satellite covers only one satellite cell is used for description. However, in actual application, a quantity of cells covered by a satellite is not limited.

Assuming that N is greater than 1, the signal quality parameter of the worst signal in the N signal quality parameters is used as the metric, which may be understood by using the following example: It is assumed that the signal quality parameters are RSRP, and satellites in the first satellite series include three satellites: a satellite 1, a satellite 2, and a satellite 3. The satellite 1 covers a satellite cell 1, the satellite 2 covers a satellite cell 2, and the satellite 3 covers a satellite cell 3. A measurement time range of the satellite cell 1 is a moment 1 to a moment 2, a measurement time range of the satellite cell 2 is a moment 3 to a moment 4, and a measurement time range of the satellite cell 3 is a moment 5 to a moment 6. Worst RSRP of the satellite cell 1 that is obtained by the terminal through measurement in the range of the moment 1 to the moment 2 is X1, worst RSRP of the satellite cell 2 that is obtained by the terminal through measurement in the range of the moment 3 to the moment 4 is X2, and worst RSRP of the satellite cell 3 that is obtained by the terminal through measurement in the range of the moment 5 to the moment 6 is X3, where X1 is less than X2, and X2 is less than X3. Therefore, the metric 1 is the worst RSRP of the satellite cell 3, that is, X1.

It is assumed that the measurement configuration information further includes information about satellite cells in one second satellite series and measurement time ranges of the satellite cells. The second satellite series includes two satellites: a satellite A and a satellite B. The satellite A covers a satellite cell A1, and the satellite B covers a satellite cell B1. A measurement time range of the satellite cell A1 is the moment 1 to the moment 2, and a measurement time range of the satellite cell B1 is a moment 7 to a moment 8. Worst RSRP of the satellite cell A1 that is obtained by the terminal through measurement in the range of the moment 1 to the moment 2 is Y1, and worst RSRP of the satellite cell B1 that is obtained by the terminal through measurement in the range of the moment 7 to the moment 8 is Y2, where Y1 is less than Y2. Therefore, the metric 1 is the worst RSRP of the satellite cell A1 of the satellite A, that is, Y1.

However, X1 is less than Y1. Smaller worst RSRP indicates that a signal of a satellite cell is more unstable. Therefore, it can be learned that signal quality of the satellite cells in the second satellite series is more stable, and the satellite cells in the first satellite series have a larger signal quality fluctuation.

### Metric 2: Variance of the N Signal Quality Parameters

Assuming that N is greater than 1, the variance of the N signal quality parameters is used as the metric, which may be understood by using the following example: It is assumed that the signal quality parameters are RSRP, and satellites in the first satellite series include three satellites: a satellite 1, a satellite 2, and a satellite 3. The satellite 1 covers a cell 1, the satellite 2 covers a satellite cell 2, and the satellite 3 covers a satellite cell 3. A measurement time range of the satellite cell 1 is a moment 1 to a moment 2, a measurement time range of the satellite cell 2 is a moment 3 to a moment 4, and a measurement time range of the satellite cell 3 is a moment 5 to a moment 6. The terminal measures RSRP of the satellite cell 1 in the range of the moment 1 to the moment 2, and calculates a variance of the RSRP of the satellite cell 1, that is, a variance 1; the terminal measures RSRP of the satellite cell 2 in the range of the moment 3 to the moment 4, and calculates a variance of the RSRP of the satellite cell 2, that is, a variance 2; and the terminal measures RSRP of the satellite cell 3 in the range of the moment 5 to the moment 6, and calculates a variance of the RSRP of the satellite cell 3, that is, a variance 3. Therefore, the metric 2 is the variance 1, the variance 2, and the variance 3. The variance 1 is less than the variance 2, and the variance 2 is less than the variance 3.

It is assumed that the measurement configuration information further includes information about satellite cells in one second satellite series and measurement time ranges of the satellite cells. The second satellite series includes two satellites: a satellite A and a satellite B. The satellite A covers a satellite cell A1, and the satellite B covers a satellite cell B1. A measurement time range of the satellite cell A1 is the moment 1 to the moment 2, and a measurement time range of the satellite cell B1 is a moment 7 to a moment 8. The terminal measures RSRP of the satellite cell A1 in the range of the moment 1 to the moment 2, and calculates a variance of the RSRP of the satellite cell 1, that is, a variance 4; and the terminal measures RSRP of the satellite cell B1 in the range of the moment 7 to the moment 8, and calculates a variance of the RSRP of the satellite cell B1, that is, a variance 5. Therefore, the metric 2 is the variance 4 and the variance 5. The variance 4 is less than the variance 5.

However, the variance 3 is less than the variance 5. A smaller variance indicates that a signal of a satellite cell is more stable. Therefore, it can be learned that the satellite cells in the second satellite series have a larger signal quality fluctuation, and signal quality of the satellite cells in the first satellite series is stable.

### Metric 3: Ratio of a Variance of the N Signal Quality Parameters to a Mean of the Signal Quality Parameters

Assuming that N is greater than 1, the ratio of the variance of the N signal quality parameters to the mean of the signal quality parameters is used as the metric, which may be understood by using the following example: It is assumed that the signal quality parameters are RSRP, and satellites in the first satellite series include three satellites: a satellite 1, a satellite 2, and a satellite 3. The satellite 1 covers a cell 1, the satellite 2 covers a cell 2, and the satellite 3 covers a cell 3. A measurement time range of the satellite cell 1 is a moment 1 to a moment 2, a measurement time range of the satellite cell 2 is a moment 3 to a moment 4, and a measurement time range of the satellite cell 3 is a moment 5 to a moment 6. The terminal measures RSRP of the satellite cell 1 in the range of the moment 1 to the moment 2, and calculates a ratio of a variance of the RSRP of the satellite cell 1 to a mean of the RSRP, that is, a ratio 1; the terminal measures RSRP of the satellite cell 2 in the range of the moment 3 to the moment 4, and calculates a ratio of a variance of the RSRP of the satellite cell 2 to a mean of the RSRP, that is, a ratio 2; and the terminal measures RSRP of the satellite cell 3 in the range of the moment 5 to the moment 6, and calculates a ratio of a variance of the RSRP of the satellite cell 3 to a mean of the RSRP, that is, a ratio 3. Therefore, the metric 3 is the ratio 1, the ratio 2, and the ratio 3. The ratio 1 is less than the ratio 2, and the ratio 2 is less than the ratio 3.

It is assumed that the measurement configuration information further includes information about satellite cells in one second satellite series and measurement time ranges of the satellite cells. The second satellite series includes two satellites: a satellite A and a satellite B. The satellite A covers a satellite cell A1, and the satellite B covers a satellite cell B1. A measurement time range of the satellite cell A1 is the moment 1 to the moment 2, and a measurement time range of the satellite cell B1 is a moment 7 to a moment 8. The terminal measures RSRP of the satellite cell A1 in the range of the moment 1 to the moment 2, and calculates a ratio of a variance of the RSRP of the satellite cell 1 to a mean of the RSRP, that is, a ratio 4; and the terminal measures RSRP of the satellite cell B1 in the range of the moment 7 to the moment 8, and calculates a ratio of a variance of the RSRP of the satellite cell B1 to a mean of the RSRP, that is, a ratio 5. Therefore, the metric 3 is the ratio 4 and the ratio 5. The ratio 4 is less than the ratio 5.

However, the ratio 3 is less than the ratio 5. A smaller ratio indicates that a signal of a satellite cell is more stable. Therefore, it can be learned that the satellite cells in the second satellite series have a larger signal quality fluctuation, and signal quality of the satellite cells in the first satellite series is stable.

Metric 4: First time length and start and end time of a time period corresponding to a signal quality parameter greater than a first quality parameter threshold in the N signal quality parameters Assuming that N is greater than 1, the first time length and the start and end time of the time period corresponding to the signal quality parameter greater than the first quality parameter threshold in the N signal quality parameters are used as the metric, which may be understood by using the following example: It is assumed that the signal quality parameters are RSRP, and satellites in the first satellite series include three satellites: a satellite 1, a satellite 2, and a satellite 3. The satellite 1 covers a satellite cell 1, the satellite 2 covers a satellite cell 2, and the satellite 3 covers a satellite cell 3. A measurement time range of the satellite cell 1 is a moment 1 to a moment 2, a measurement time range of the satellite cell 2 is a moment 3 to a moment 4, and a measurement time range of the satellite cell 3 is a moment 5 to a moment 6. The terminal measures RSRP of the satellite cell 1 in the range of the moment 1 to the moment 2, and calculates a time length in which RSRP of the satellite cell 1 is greater than a first quality parameter threshold W and start and end time of the time length (for example, the terminal measures the RSRP of the satellite cell 1 in the range of the moment 1 to the moment 2, and if RSRP of the satellite cell 1 measured by the terminal in a range of the moment 1.2 to the moment 1.8 is greater than W, 0.6 (1.8−1.2=0.6) is recorded as the first time length, the range of the moment 1.2 to the moment 1.8 is recorded as the start and end time of the first time length, and 0.6 and the range of the moment 1.2 to the moment 1.8 are used as the metric 4). The terminal measures RSRP of the satellite cell 2 in the range of the moment 3 to the moment 4, and calculates a time length in which RSRP of the satellite cell 2 is greater than W and start and end time of the time length (for example, the terminal measures the RSRP of the satellite cell 2 in the range of the moment 3 to the moment 4, and if RSRP of the satellite cell 2 measured by the terminal in a range of the moment 3.1 to the moment 3.2 is greater than W and RSRP of the satellite cell 2 measured by the terminal in a range of the moment 3.5 to the moment 3.9 is greater than W, 0.6 ((3.2−3.1)+ (3.9−3.5)=0.5) is recorded as the first time length, the range of the moment 3.1 to the moment 3.2 and the range of the moment 3.5 to the moment 3.9 are respectively recorded as the start and end time of the first time length, and 0.6, the range of the moment 3.1 to the moment 3.2, and the range of the moment 3.5 to the moment 3.9 are used as the metric 4). The terminal measures RSRP of the satellite cell 3 in the range of the moment 5 to the moment 6, and calculates a time length in which RSRP of the satellite cell 3 is greater than W and start and end time of the time length (for example, if RSRP of the satellite cell 3 measured by the terminal in a range of the moment 5.5 to the moment 5.7 is greater than W, 0.2 (5.7−5.5=0.2) is recorded as the first time length, the range of the moment 5.5 to the moment 5.7 is recorded as the start and end time of the first time length, and 0.2 and the range of the moment 5.5 to the moment 5.7 are recorded as the metric 4). 0.2 is less than 0.5, and 0.5 is less than 0.6.

It is assumed that the measurement configuration information further includes information about satellite cells in one second satellite series and measurement time ranges of the satellite cells. The second satellite series includes two satellites: a satellite A and a satellite B. The satellite A covers a satellite cell A1, and the satellite B covers a satellite cell B1. A measurement time range of the satellite cell A1 is the moment 1 to the moment 2, and a measurement time range of the satellite cell B1 is a moment 7 to a moment 8. The terminal measures RSRP of the satellite cell A1 in the range of the moment 1 to the moment 2, and calculates a time length in which RSRP of the satellite cell A1 is greater than the first quality parameter threshold W and start and end time of the time length (for example, the terminal measures the RSRP of the satellite cell 1 in the range of the moment 1 to the moment 2, and if RSRP of the satellite cell A1 measured by the terminal in a range of the moment 1.5 to the moment 1.8 is greater than W, 0.3 (1.8−1.5=0.3) is recorded as the first time length, the range of the moment 1.5 to the moment 1.8 is recorded as the start and end time of the first time length, and 0.3 and the range of the moment 1.5 to the moment 1.8 are used as the metric 4). The terminal measures RSRP of the satellite cell B1 in the range of the moment 7 to the moment 8, and calculates a time length in which RSRP of the satellite cell B1 is greater than W and start and end time of the time length (for example, the terminal measures the RSRP of the satellite cell B1 in the range of the moment 7 to the moment 8, and if RSRP of the satellite cell B1 measured by the terminal in a range of the moment 7.1 to the moment 7.9 is greater than W and RSRP of the satellite cell B1 measured by the terminal in a range of the moment 7.1 to the moment 7.9 is greater than W, 0.8 (7.9−7.1=0.8) is recorded as the first time length, the range of the moment 7.1 to the moment 7.9 is recorded as the start and end time of the first time length, and 0.8 and the range of the moment 7.1 to the moment 7.9 are used as the metric 4). 0.3 is less than 0.8.

However, the time length of 0.2 greater than the threshold is less than 0.3. A longer first time length indicates that a signal of a satellite cell is more stable. Therefore, it can be learned that the satellite cells in the first satellite series have a larger signal quality fluctuation, and signal quality of the satellite cells in the second satellite series is stable.

Metric 5: Second Time Length and Start and End Time of a Time Period Corresponding to a Signal Quality Parameter Less than a Second Quality Parameter Threshold in the N Signal Quality Parameters

It should be noted that the second quality parameter threshold shown in the metric 5 and the first quality parameter threshold in the metric 4 may be set to a same value, or may be set to different values. This is not specifically limited in this application. The following uses an example in which the first quality parameter threshold is different from the second quality parameter threshold for description.

Assuming that N is greater than 1, the second time length and the start and end time of the time period corresponding to the signal quality parameter less than the second quality parameter threshold in the N signal quality parameters are used as the metric, which may be understood by using the following example: It is assumed that the signal quality parameters are RSRP, and satellites in the first satellite series include three satellites: a satellite 1, a satellite 2, and a satellite 3. The satellite 1 covers a cell 1, the satellite 2 covers a cell 2, and the satellite 3 covers a satellite cell 3. A measurement time range of the satellite cell 1 is a moment 1 to a moment 2, a measurement time range of the satellite cell 2 is a moment 3 to a moment 4, and a measurement time range of the satellite cell 3 is a moment 5 to a moment 6. The terminal measures RSRP of the satellite cell 1 in the range of the moment 1 to the moment 2, and calculates a time length in which RSRP of the satellite cell 1 is less than a second quality parameter threshold S and start and end time of the time length (for example, the terminal measures the RSRP of the satellite cell 1 in the range of the moment 1 to the moment 2, and if RSRP of the satellite cell 1 measured by the terminal in a range of the moment 1.8 to the moment 2 is less than S, 0.2 (2−1.8=0.2) is recorded as the second time length, the range of the moment 1.8 to the moment 2 is recorded as the start and end time of the second time length, and 0.2 and the range of the moment 1.8 to the moment 2 are used as the metric 5). The terminal measures RSRP of the satellite cell 2 in the range of the moment 3 to the moment 4, and calculates a time length in which RSRP of the satellite cell 2 is less than S and start and end time of the time length (for example, the terminal measures the RSRP of the satellite cell 2 in the range of the moment 3 to the moment 4, and if RSRP of the satellite cell 2 measured by the terminal in a range of the moment 3.3 to the moment 3.5 is less than S and RSRP of the satellite cell 2 measured by the terminal in a range of the moment 3.9 to the moment 4 is less than S, 0.3 ((3.5−3.3)+ (4−3.9)=0.3) is recorded as the second time length, the range of the moment 3.3 to the moment 3.5 and the range of the moment 3.9 to the moment 4 are respectively recorded as the start and end time of the second time length, and 0.3, the range of the moment 3.3 to the moment 3.5, and the range of the moment 3.9 to the moment 4 are used as the metric 5). The terminal measures RSRP of the satellite cell 3 in the range of the moment 5 to the moment 6, and calculates a time length in which RSRP of the satellite cell 3 is less than S and start and end time of the time length (for example, if RSRP of the satellite cell 3 measured by the terminal in a range of the moment 5 to the moment 5.5 is less than S, 0.5 (5.5−5=0.5) is recorded as the second time length, the range of the moment 5 to the moment 5.5 is recorded as the start and end time of the second time length, and 0.5 and the range of the moment 5 to the moment 5.5 are recorded as the metric 5). 0.2 is less than 0.3, and 0.3 is less than 0.5.

It is assumed that the measurement configuration information further includes information about satellite cells in one second satellite series and measurement time ranges of the satellite cells. The second satellite series includes two satellites: a satellite A and a satellite B. The satellite A covers a satellite cell A1, and the satellite B covers a satellite cell B1. A measurement time range of the satellite cell A1 is the moment 1 to the moment 2, and a measurement time range of the satellite cell B1 is a moment 7 to a moment 8. The terminal measures RSRP of the satellite cell A1 in the range of the moment 1 to the moment 2, and calculates a time length in which RSRP of the satellite cell A1 is less than the second quality parameter threshold S and start and end time of the time length (for example, the terminal measures the RSRP of the satellite cell A1 in the range of the moment 1 to the moment 2, and if RSRP of the satellite cell A1 measured by the terminal in a range of the moment 1.5 to the moment 1.8 is less than S, 0.3 (1.8−1.5=0.3) is recorded as the second time length, the range of the moment 1.5 to the moment 1.8 is recorded as the start and end time of the second time length, and 0.3 and the range of the moment 1.5 to the moment 1.8 are used as the metric 5). The terminal measures RSRP of the satellite cell B1 in the range of the moment 7 to the moment 8, and calculates a time length in which RSRP of the satellite cell B1 is less than S and start and end time of the time length (for example, the terminal measures the RSRP of the satellite cell B1 in the range of the moment 7 to the moment 8, and if RSRP of the satellite cell B1 measured by the terminal in a range of the moment 7.1 to the moment 7.9 is less than S and RSRP of the satellite cell B1 measured by the terminal in a range of the moment 7.1 to the moment 7.9 is less than S, 0.8 (7.9−7.1=0.8) is recorded as the second time length, the range of the moment 7.1 to the moment 7.9 is recorded as the start and end time of the second time length, and 0.8 and the range of the moment 7.1 to the moment 7.9 are used as the metric 5). 0.3 is less than 0.8.

However, the time period of 0.5 corresponding to the signal quality parameter less than the second quality parameter threshold is less than 0.8. A longer second time length indicates that a signal of a satellite cell is more unstable. Therefore, it can be learned that the satellite cells in the second satellite series have a larger signal quality fluctuation, and signal quality of the satellite cells in the first satellite series is stable.

### Metric 6: Ratio of a First Time Length to the Measurement Time Range of the First Satellite Cell

Assuming that N is greater than 1, the ratio of the first time length to the measurement time range of the first satellite cell is used as the metric, which may be understood by using the following example: It is assumed that the signal quality parameters are RSRP, and satellites in the first satellite series include three satellites: a satellite 1, a satellite 2, and a satellite 3. The satellite 1 covers a cell 1, the satellite 2 covers a cell 2, and the satellite 3 covers a cell 3. A measurement time range of the satellite cell 1 is a moment 1 to a moment 2, a measurement time range of the satellite cell 2 is a moment 3 to a moment 4, and a measurement time range of the satellite cell 3 is a moment 5 to a moment 6. The terminal measures RSRP of the satellite cell 1 in the range of the moment 1 to the moment 2, and calculates a ratio of a time length in which RSRP of the satellite cell 1 is greater than a first quality parameter threshold W to the measurement time range (for example, the terminal measures the RSRP of the satellite cell 1 in the range of the moment 1 to the moment 2, and if RSRP of the satellite cell 1 measured by the terminal in a range of the moment 1.2 to the moment 1.8 is greater than W, 0.6 ((1.8−1.2=0.6)/(2−1=1)) is recorded as the metric 6). The terminal measures RSRP of the satellite cell 2 in the range of the moment 3 to the moment 4, and calculates a ratio of a time length in which RSRP of the satellite cell 2 is greater than W to the measurement time range (for example, the terminal measures the RSRP of the satellite cell 2 in the range of the moment 3 to the moment 4, and if RSRP of the satellite cell 2 measured by the terminal in a range of the moment 3.1 to the moment 3.2 is greater than W and RSRP of the satellite cell 2 measured by the terminal in a range of the moment 3.5 to the moment 3.9 is greater than W, 0.6 (((3.2−3.1)+ (3.9−3.5)−0.5)/(4−3)=0.6) is recorded as the metric 6). The terminal measures RSRP of the satellite cell 3 in the range of the moment 5 to the moment 6, and calculates a ratio of a time length in which RSRP of the satellite cell 3 is greater than W to the measurement time range (for example, if RSRP of the satellite cell 3 measured by the terminal in a range of the moment 5.5 to the moment 5.7 is greater than W, 0.2 ((5.7−5.5=0.2)/(6−5)−0.2) is recorded as the metric 6). 0.2 is less than 0.5, and 0.5 is less than 0.6.

It is assumed that the measurement configuration information further includes information about satellite cells in one second satellite series and measurement time ranges of the satellite cells. The second satellite series includes two satellites: a satellite A and a satellite B. The satellite A covers a satellite cell A1, and the satellite B covers a satellite cell B1. A measurement time range of the satellite cell A1 is the moment 1 to the moment 2, and a measurement time range of the satellite cell B1 is a moment 7 to a moment 8. The terminal measures RSRP of the satellite cell A1 in the range of the moment 1 to the moment 2, and calculates a ratio of a time length in which RSRP of the satellite cell A1 is greater than the first quality parameter threshold W to the measurement time range (for example, the terminal measures the RSRP of the satellite cell 1 in the range of the moment 1 to the moment 2, and if RSRP of the satellite cell A1 measured by the terminal in a range of the moment 1.5 to the moment 1.8 is greater than W, 0.3 ((1.8−1.5=0.3)/(2−1)) is recorded as the metric 6). The terminal measures RSRP of the satellite cell B1 in the range of the moment 7 to the moment 8, and calculates a ratio of a time length in which RSRP of the satellite cell B1 is greater than W to the measurement time range (for example, the terminal measures the RSRP of the satellite cell B1 in the range of the moment 7 to the moment 8, and if RSRP of the satellite cell B1 measured by the terminal in a range of the moment 7.1 to the moment 7.9 is greater than W and RSRP of the satellite cell B1 measured by the terminal in a range of the moment 7.1 to the moment 7.9 is greater than W, 0.8 ((7.9−7.1=0.8)/(8−7)) is recorded as the metric 6). 0.3 is less than 0.8.

However, 0.2 is less than 0.3. A larger ratio indicates that a signal of a satellite cell is more stable. Therefore, it can be learned that the satellite cells in the first satellite series have a larger signal quality fluctuation, and signal quality of the satellite cells in the second satellite series is stable.

### Metric 7: Ratio of a Second Time Length to the Measurement Time Range of the First Satellite Cell

Assuming that N is greater than 1, the ratio of the second time length to the measurement time range of the first satellite cell is used as the metric, which may be understood by using the following example: It is assumed that the signal quality parameters are RSRP, and satellites in the first satellite series include three satellites: a satellite 1, a satellite 2, and a satellite 3. The satellite 1 covers a cell 1, the satellite 2 covers a cell 2, and the satellite 3 covers a cell 3. A measurement time range of the satellite cell 1 is a moment 1 to a moment 2, a measurement time range of the satellite cell 2 is a moment 3 to a moment 4, and a measurement time range of the satellite cell 3 is a moment 5 to a moment 6. The terminal measures RSRP of the satellite cell 1 in the range of the moment 1 to the moment 2, and calculates a ratio of a time length in which RSRP of the satellite cell 1 is less than a second quality parameter threshold S to the measurement time range (for example, the terminal measures the RSRP of the satellite cell 1 in the range of the moment 1 to the moment 2, and if RSRP of the satellite cell 1 measured by the terminal in a range of the moment 1.8 to the moment 2 is less than S, 0.2 ((2−1.8=0.2)/(2−1=1)) is recorded as the metric 7). The terminal measures RSRP of the satellite cell 2 in the range of the moment 3 to the moment 4, and calculates a ratio of a time length in which RSRP of the satellite cell 2 is less than S to the measurement time range (for example, the terminal measures the RSRP of the satellite cell 2 in the range of the moment 3 to the moment 4, and if RSRP of the satellite cell 2 measured by the terminal at the moment 3.3 to the moment 3.5 is less than S and RSRP of the satellite cell 2 measured by the terminal in a range of the moment 3.9 to the moment 4 is less than S, 0.3 (((3.5−3.3)+ (4−3.9)=0.3)/(4−3)) is recorded as the metric 7). The terminal measures RSRP of the satellite cell 3 in the range of the moment 5 to the moment 6, and calculates a ratio of a time length in which RSRP of the satellite cell 3 is less than S to the measurement time range (for example, if RSRP of the satellite cell 3 measured by the terminal in a range of the moment 5 to the moment 5.5 is less than S, 0.5 ((5.5−5=0.5)/(6−5)) is recorded as the metric 7). 0.2 is less than 0.3, and 0.3 is less than 0.5.

It is assumed that the measurement configuration information further includes information about satellite cells in one second satellite series and measurement time ranges of the satellite cells. The second satellite series includes two satellites: a satellite A and a satellite B. The satellite A covers a satellite cell A1, and the satellite B covers a satellite cell B1. A measurement time range of the satellite cell A1 is the moment 1 to the moment 2, and a measurement time range of the satellite cell B1 is a moment 7 to a moment 8. The terminal measures RSRP of the satellite cell A1 in the range of the moment 1 to the moment 2, and calculates a ratio of a time length in which RSRP of the satellite cell A1 is less than the second quality parameter threshold S to the measurement time range (for example, the terminal measures the RSRP of the satellite cell A1 in the range of the moment 1 to the moment 2, and if RSRP of the satellite cell A1 measured by the terminal in a range of the moment 1.5 to the moment 1.8 is less than S, 0.3 ((1.8−1.5=0.3)/(2−1)) is recorded as the metric 7). The terminal measures RSRP of the satellite cell B1 in the range of the moment 7 to the moment 8, and calculates a ratio of a time length in which RSRP of the satellite cell B1 is less than S to the measurement time range (for example, the terminal measures the RSRP of the satellite cell B1 in the range of the moment 7 to the moment 8, and if RSRP of the satellite cell B1 measured by the terminal in a range of the moment 7.1 to the moment 7.9 is less than S and RSRP of the satellite cell B1 measured by the terminal in a range of the moment 7.1 to the moment 7.9 is less than S, 0.8 ((7.9−7.1=0.8)/(8−7)) is recorded as the metric 7). 0.3 is less than 0.8.

However, 0.5 is less than 0.8. A larger ratio indicates that a signal of a satellite cell is more unstable. Therefore, it can be learned that the satellite cells in the second satellite series have a larger signal quality fluctuation, and signal quality of the satellite cells in the first satellite series is stable.

In addition, it should be further noted that, in actual application, the foregoing plurality of metrics may jointly indicate a signal quality fluctuation of a satellite cell. For example, the metric 1 and the metric 2 jointly perform an indication. A satellite cell with a worst signal quality parameter in the metric 1 and a largest variance of quality parameters in the metric 2 is determined as a cell with a large signal quality fluctuation. Alternatively, a satellite cell with a signal quality parameter greater than a threshold in the metric 1 and a variance of quality parameters greater than a threshold in the metric 2 is determined as a cell with a large signal quality fluctuation. In addition, another determining manner may also be involved. Examples are not provided one by one herein in this application.

In addition, it should be further noted that, in actual application, a priority sequence may be set for the foregoing metrics, and signal quality of a satellite cell is determined based on a priority. It is assumed that there are three metrics, where a priority of a metric 3 is higher than a priority of measurement 2, and the priority of the metric 2 is higher than a priority of a metric 1. In actual application, if cells with signal quality fluctuations fed back by using different metrics are different, a cell with a signal quality fluctuation determined by using a metric with a higher priority may be used as a reference. For example, a fluctuation of a satellite cell determined by using the metric 3 is used as a reference. An example is only used for description in this application, and this is not specifically limited.

Further, signal quality fluctuations of satellite cells in different satellite series may be determined based on the foregoing metric. A network device may indicate, based on the metric, the terminal to hand over to a satellite cell in a satellite series with more stable signal quality to receive a service. The terminal may alternatively select, based on signal quality fluctuations of satellite cells in different satellite series, a satellite cell in a satellite series with more stable signal quality to receive a service. Certainly, in actual application, a to-be-selected specific satellite cell in a satellite series with more stable signal quality is not specifically limited herein. For example, a satellite cell may be determined based on a time period in which the satellite cell can provide a service for the terminal and a current time period. This is not specifically limited in this application.

In addition, the terminal reports a metric to the network device if the terminal is in an RRC connected state, so that the network device determines whether to perform a cell handover operation; or the terminal determines, if the terminal is in an RRC non-connected state, whether to start signal measurement in a satellite cell or whether to perform satellite cell reselection.

In this application, the terminal performs cell signal measurement based on a correlation of coverage of satellites in an orbit or a track and a measurement time range of a satellite in a series in the measurement configuration information, so that a measurement object and a start and end time range are clearly constrained. In this manner, unnecessary handover and reselection can be reduced, thereby reducing signaling exchange, and improving data processing efficiency. In addition, the metric indicates a signal quality fluctuation of the at least one satellite cell in the measurement time range, so that the terminal can be prevented from receiving a communication service from only a satellite close to the terminal (where the satellite may actually be subject to signal blocking, or the like, that is, the case in FIG. 6) in a long term, and communication quality can be ensured.

The following describes other measurement configuration information that may be involved in different cases.

### Case 1: The Terminal is in the RRC Connected State.

Optionally, the measurement configuration information further includes a report configuration, and the report configuration may include: report content configuration information, indicating a type of a metric included in a measurement report (that is, a metric to be reported in the measurement report); and a trigger event, indicating a trigger condition for reporting the measurement report.

Optionally, the trigger event may include at least one of the following:
a first trigger event, indicating to report the measurement report when a signal quality fluctuation of a satellite cell in a satellite series of the terminal is greater than a first fluctuation threshold;
a second trigger event, indicating to report the measurement report when the signal quality fluctuation of the satellite cell in the satellite series of the terminal is less than a second fluctuation threshold;
a third trigger event, indicating to report the measurement report when a signal quality fluctuation of a satellite cell in a satellite series other than the satellite series of the terminal is greater than a third fluctuation threshold; and
a fourth trigger event, indicating to report the measurement report when the signal quality fluctuation of the satellite cell in the satellite series other than the satellite series of the terminal is greater than a signal quality fluctuation of a satellite cell in the first satellite series.

The satellite series of the terminal is a satellite series to which a serving satellite cell of the terminal belongs. A higher signal quality fluctuation of a cell indicates that a signal of the cell is more unstable.

In addition, it should be further noted that the first fluctuation threshold, the second fluctuation threshold, and the third fluctuation threshold may be set to a same threshold, or may be set to different thresholds. This is not specifically limited in this application.

As shown in Table 6 below, only four trigger events are used as examples for description in Table 6. However, in actual application, another trigger event may also be included.

TABLE 6

| Trigger | | | |
|---|---|---|---|
| event | Meaning | Entry condition | Exit condition |
| L1 | The fluctuation (signal quality | Ls < Thresh + offset | Ls > Thresh − offset |
| | fluctuation) of the satellite cell in the | | |
| | series of the terminal is less than a | | |
| | threshold (that is, the first fluctuation | | |
| | threshold) | | |
| L2 | The fluctuation of the satellite cell in | Ls > Thresh + offset | Ls < Thresh − offset |
| | the series of the terminal is greater | | |
| | than the threshold | | |
| L3 | A fluctuation of a satellite cell in | Ln > Thresh + offset | Ln < Thresh − offset |
| | another series is greater than the | | |
| | threshold | | |
| L4 | The fluctuation of the satellite cell in | Ln > Ls + offset | Ln < Ls − offset |
| | the another series is greater than the | | |
| | fluctuation of the satellite cell in the | | |
| | series of the terminal | | |
| L5 | . . . | . . . | . . . |

Ls indicates a ratio of a quality variance to average quality of satellite cells in the current series of the terminal; Ln indicates a ratio of a quality variance to average quality of satellite cells in the another series; Thresh indicates the first fluctuation threshold; and Offset indicates an offset for avoiding a ping-pong effect, where the offset is optional.

The trigger event L3 is used as an example. If UE finds that a fluctuation of a satellite in another series is better than a fluctuation of a satellite in a series in which the UE is currently located (in other words, a signal of the satellite in the another series is more stable), reporting is triggered. Then, a base station may indicate the UE to hand over to a satellite cell in the another series.

Similar to the design of a plurality of triggering amounts in a conventional technology, a plurality of trigger events may be designed. For example, triggering may be performed based on only “worst quality” (similar to RSRP-based triggering); or triggering may be performed based on both the “worst quality” and a “quality variance” (similar to RSRP-and-RSRQ-based triggering); or triggering may be performed based on an indicator, for example, the “worst quality”, but a measurement report includes a plurality of measurement results, for example, the “worst quality” and the “quality variance” (similar to RSRP-based triggering and RSRQ-based filtering); or triggering may be performed based on a combination of variables such as RSRP and RSRQ and a fluctuation condition indicator, where a specific combination is not limited.

### Case 2: The Terminal is in the RRC Non-Connected State.

Optionally, the measurement configuration information further includes a measurement condition of a neighboring satellite cell, where the measurement condition includes at least one of the following.

A priority of a satellite cell in a satellite series other than a satellite series of the terminal is higher than a priority of a satellite cell in the satellite series of the terminal, where the satellite series of the terminal is a satellite series to which a serving satellite cell of the terminal belongs.

For example, a satellite series currently serving the terminal is a satellite series 1, and satellite series adjacent to the satellite series 1 include a satellite series 2 and a satellite series 3, where a priority of the satellite series 3 is higher than a priority of the satellite series 1, and a priority of the satellite series 2 is lower than the priority of the satellite series 1. In this case, signal measurement on a satellite cell in the satellite series 3 is triggered. In addition, if the priorities of both the satellite series 2 and the satellite series 3 are higher than the priority of the satellite series 1, the priorities of the satellite series 2 and the satellite series 3 may be sorted, and a satellite cell in a satellite series with a highest priority is selected for signal measurement.

The priority of the satellite cell in the satellite series other than the satellite series of the terminal is not higher than the priority of the satellite cell in the satellite series of the terminal, and a signal quality fluctuation of the satellite cell in the satellite series of the terminal is greater than a fourth fluctuation threshold.

For example, a satellite series currently serving the terminal is a satellite series 1, and a satellite series adjacent to the satellite series 1 includes a satellite series 3, where a priority of the satellite series 3 is not higher than a priority of the satellite series 1. However, a signal quality fluctuation of a satellite cell in the satellite series 1 is higher than the fourth fluctuation threshold, in other words, signal stability of a satellite cell in the current satellite series 1 is relatively poor. Therefore, signal measurement is performed on a satellite cell in the satellite series 3.

Optionally, the measurement configuration information further includes a satellite cell reselection condition, and the reselection condition includes at least one of the following.

In a preset time threshold, signal quality of the satellite cell in the satellite series other than the satellite series of the terminal is not greater than the fourth fluctuation threshold; and in the preset time threshold, signal quality of the satellite cell in the satellite series other than the satellite series of the terminal is not higher than signal quality of the satellite cell in the satellite series of the terminal. In other words, in the preset time threshold, a signal of a neighboring cell of a satellite cell currently serving the terminal is more stable than a signal of the satellite cell currently serving the terminal. Therefore, the neighboring cell may be used as a new satellite cell serving the terminal.

In addition, it should be further noted that the preset time threshold may be set based on a user requirement, for example, set to one day, one week, or 10 hours. A specific time range of the preset time threshold is not limited in this application.

The base station configures (or agrees with the UE) a reselection condition related to fluctuations at a large time granularity of different satellite series for the UE, adds, to a reselection consideration indicator when there is a low long-term fluctuation degree in coverage of a satellite series in which the UE is located, the satellite series in which the UE is located, and preferentially indicates the UE to camp on a satellite series with a relatively small long-term fluctuation. For example, if recent signal quality of target satellites in two different orbits is similar (where a difference is less than a threshold), but signal stability of a target satellite in one of the orbits is higher, the UE should camp on a satellite cell in the orbit with higher long-term signal quality.

In addition, a constraint of long-time measurement may also be added to a measurement behavior of a current indicator. For example, in the conventional technology, reselection for cells with an equal priority is performed according to an R criterion. In the R criterion, R (Rank) values are calculated for measurement results of neighboring cells and a current serving cell based on cell signal quality, and then the measurement results are sorted based on the R values. If an R value of a neighboring cell is greater than that of the current serving cell, the neighboring cell meets the reselection criterion. If a plurality of neighboring cells meet the reselection criterion, the best one is selected. If a neighboring cell continuously meets the R criterion for TreselectionRAT, the UE starts reselection to the cell. The R value is calculated as follows:

Rₛ=Q_{meas,s}+Q_{hyst}−Qoffsetₜₑₘₚ; and

Rₙ=Q_{meas,n}−Q_{offset}−Qoffsetₜₑₘₚ.

Q_{meas,s} is a calculation parameter of the R criterion, indicates signal quality of a current serving satellite cell, and may be obtained from a system message NA. Q_{meas,n} is a calculation parameter of the R criterion, indicates signal quality of a neighboring cell of the current serving satellite cell, and may be obtained from the system message NA. Q_{Hyst} is a calculation parameter of the R criterion, indicates a reselection hysteresis value of the current serving satellite cell, and may be obtained from a system message SIB2. Qoffset is a calculation parameter of the R criterion. In an intra-frequency reselection scenario, Qoffset is a value QoffsetCell and is obtained from a SIB3. In an inter-frequency reselection scenario, Qoffset is equal to QoffsetCell+QoffsetFreq, where both QoffsetCell and QoffsetFreq are obtained from a SIB4. Qoffsettemp is a calculation parameter of the R criterion, and may be obtained from a system message SIB1. Both Q_{meas,s} and Q_{meas,n} are metrics.

In addition, optionally, a satellite cell of a satellite in the first satellite series may form a hypercell, and a satellite cell of a satellite in the second satellite series may form a hypercell. Cell reselection and handover of a satellite in the hypercell do not require signaling exchange between the network device and the terminal. In this manner, signaling overheads can be reduced, and data processing efficiency can be improved. Signaling exchange between the network device and the terminal is triggered only during satellite cell handover between satellites with different series identifiers.

The foregoing mainly describes the solutions provided in embodiments of this application from a perspective of device interaction. It may be understood that, to implement the foregoing functions, each device may include a corresponding hardware structure and/or software module for performing each function. A person skilled in the art should be easily aware that, in embodiments of this application, the units and algorithm steps in the examples described with reference to embodiments disclosed in this specification can be implemented by hardware or a combination of hardware and computer software. Whether a function is performed by hardware or hardware driven by computer software depends on particular applications and implementation constraints of the technical solutions. A person skilled in the art may use different methods to implement the described functions for each particular application, but it should not be considered that the implementation goes beyond the scope of this application.

In embodiments of this application, the device may be divided into functional units based on the foregoing method examples. For example, each functional unit may be obtained through division based on a corresponding function, or two or more functions may be integrated into one unit. The integrated unit may be implemented in a form of hardware, or may be implemented in a form of a software functional unit.

When the integrated unit is used, FIG. 10 is a block diagram of a possible example of a communication apparatus according to an embodiment of this application. As shown in FIG. 10, the communication apparatus 1000 may include a processing unit 1001 and a transceiver unit 1002. The processing unit 1001 is configured to control and manage an action of the communication apparatus 1000. The transceiver unit 1002 is configured to support communication between the communication apparatus 1000 and another device. Optionally, the transceiver unit 1002 may include a receiving unit and/or a sending unit, respectively configured to perform a receiving operation and a sending operation. Optionally, the communication apparatus 1000 may further include a storage unit, configured to store program code and/or data of the communication apparatus 1000. The transceiver unit may be referred to as an input/output unit, a communication unit, or the like, and the transceiver unit may be a transceiver. The processing unit may be a processor. When the communication apparatus is a module (for example, a chip) in a communication device, the transceiver unit may be an input/output interface, an input/output circuit, an input/output pin, or the like, and may also be referred to as an interface, a communication interface, an interface circuit, or the like; and the processing unit may be a processor, a processing circuit, a logic circuit, or the like. Specifically, the apparatus may be the foregoing terminal, network device, satellite, or the like.

In an embodiment, the transceiver unit 1002 is configured to obtain measurement configuration information, where the measurement configuration information includes information about at least one satellite cell and a measurement time range of the at least one satellite cell, the at least one satellite cell includes a first satellite cell, a measurement time range of the first satellite cell is all or a part of a time length in which a coverage area of the first satellite cell is in a first area, and the first area is an area in which a terminal is located; and the processing unit 1001 is configured to measure a signal of the at least one satellite cell in the first area based on the measurement configuration information, to obtain a metric, where the metric indicates a signal quality fluctuation of the at least one satellite cell in the measurement time range.

Optionally, in an optional implementation, satellites corresponding to the at least one satellite cell include satellites in a first satellite series and a second satellite series, and satellites in a same satellite series have a same orbit or have a same earth projection track.

Optionally, satellite cells of different satellites in the same satellite series have different measurement start and end time.

Optionally, the measurement configuration information further includes an identifier of a satellite cell and a measurement frequency of the at least one satellite cell.

Optionally, the terminal obtains N signal quality parameters through measurement in the measurement time range of the first satellite cell, and a metric of the first satellite cell includes at least one of the following:
a signal quality parameter of a worst signal in the N signal quality parameters;
a variance of the N signal quality parameters;
a ratio of the variance of the N signal quality parameters to a mean of the signal quality parameters;
a first time length and start and end time of a time period corresponding to a signal quality parameter greater than a first quality parameter threshold in the N signal quality parameters;
a second time length and start and end time of a time period corresponding to a signal quality parameter less than a second quality parameter threshold in the N signal quality parameters;
a ratio of the first time length to the measurement time range of the first satellite cell; and
a ratio of the second time length to the measurement time range of the first satellite cell.

Optionally, the signal quality parameter is one of the following: RSRP, an RSSI, RSRQ, and an SINR.

Optionally, the measurement configuration information further includes a report configuration, and the report configuration includes: report content configuration information, indicating a type of the metric included in a measurement report; and a trigger event, indicating a trigger condition for reporting the measurement report.

Optionally, the trigger event includes at least one of the following:
a first trigger event, indicating to report the measurement report when a signal quality fluctuation of a satellite cell in a satellite series of the terminal is greater than a first fluctuation threshold;
a second trigger event, indicating to report the measurement report when the signal quality fluctuation of the satellite cell in the satellite series of the terminal is less than a second fluctuation threshold;
a third trigger event, indicating to report the measurement report when a signal quality fluctuation of a satellite cell in a satellite series other than the satellite series of the terminal is greater than a third fluctuation threshold; and
a fourth trigger event, indicating to report the measurement report when the signal quality fluctuation of the satellite cell in the satellite series other than the satellite series of the terminal is greater than a signal quality fluctuation of a satellite cell in the first satellite series, where
the satellite series of the terminal is a satellite series to which a serving satellite cell of the terminal belongs.

Optionally, the measurement configuration information further includes a measurement condition of a neighboring satellite cell, where the measurement condition of the neighboring satellite cell includes at least one of the following:
a priority of a satellite cell in a satellite series other than a satellite series of the terminal is higher than a priority of a satellite cell in the satellite series of the terminal; and
the priority of the satellite cell in the satellite series other than the satellite series of the terminal is not higher than the priority of the satellite cell in the satellite series of the terminal, and a signal quality fluctuation of the satellite cell in the satellite series of the terminal is greater than a fourth fluctuation threshold, where
the satellite series of the terminal is a satellite series to which a serving satellite cell of the terminal belongs.

Optionally, the measurement configuration information further includes a satellite cell reselection condition, and the reselection condition includes at least one of the following:
in a preset time threshold, signal quality of the satellite cell in the satellite series other than the satellite series of the terminal is not greater than the fourth fluctuation threshold; and
in the preset time threshold, signal quality of the satellite cell in the satellite series other than the satellite series of the terminal is not higher than signal quality of the satellite cell in the satellite series of the terminal.

Optionally, the measurement configuration information further includes a series identifier of the first satellite series and a series identifier of the second satellite series.

Optionally, a satellite cell of a satellite in the first satellite series forms a hypercell, and a satellite cell of a satellite in the second satellite series forms a hypercell.

Optionally, the transceiver unit 1002 is further configured to receive the measurement configuration information from a network device.

Optionally, if the terminal is in a radio resource control RRC connected state, the transceiver unit 1002 is further configured to report the metric; or if the terminal is in an RRC non-connected state, the processing unit 1001 is further configured to determine a signal quality fluctuation of the satellite cell based on the metric.

Optionally, if the terminal is in the RRC connected state the terminal reports the metric; or if the terminal is in the RRC non-connected state, the terminal determines whether to start signal measurement in the satellite cell or whether to perform satellite cell reselection.

In another embodiment, the processing unit 1001 is configured to determine measurement configuration information, where the measurement configuration information includes information about at least one satellite cell and a measurement time range of the at least one satellite cell, the at least one satellite cell includes a first satellite cell, a measurement time range of the first satellite cell is all or a part of a time length in which a coverage area of the first satellite cell is in a first area, and the first area is an area in which a terminal is located; and the transceiver unit 1002 is configured to send the measurement configuration information.

Optionally, satellites corresponding to the at least one satellite cell include satellites in a first satellite series and a second satellite series, and satellites in a same satellite series have a same orbit or have a same earth projection track.

Optionally, satellite cells of different satellites in the same satellite series have different measurement start and end time.

Optionally, the measurement configuration information further includes a report configuration, and the report configuration includes:
report content configuration information, indicating a type of a metric included in a measurement report; and
a trigger event, indicating a trigger condition for reporting the measurement report.

Optionally, the trigger event includes at least one of the following:
a first trigger event, indicating to report the measurement report when a signal quality fluctuation of a satellite cell in a satellite series of the terminal is greater than a first fluctuation threshold;
a second trigger event, indicating to report the measurement report when the signal quality fluctuation of the satellite cell in the satellite series of the terminal is less than a second fluctuation threshold;
a third trigger event, indicating to report the measurement report when a signal quality fluctuation of a satellite cell in a satellite series other than the satellite series of the terminal is greater than a third fluctuation threshold; and
a fourth trigger event, indicating to report the measurement report when the signal quality fluctuation of the satellite cell in the satellite series other than the satellite series of the terminal is greater than the signal quality fluctuation of the satellite cell in the satellite series of the terminal, where
the satellite series of the terminal is a satellite series to which a serving satellite cell of the terminal belongs.

Optionally, the transceiver unit 1002 is further configured to receive the measurement report reported by the terminal based on the measurement configuration information, where the measurement report includes the metric obtained by measuring a signal of the at least one satellite cell in the first area by the terminal based on the measurement configuration information; and the processing unit 1001 is further configured to make satellite cell handover decision on the terminal based on the measurement report.

Optionally, the terminal obtains N signal quality parameters through measurement in the measurement time range of the first satellite cell, and a metric of the first satellite cell includes at least one of the following:
a signal quality parameter of a worst signal in the N signal quality parameters;
a variance of the N signal quality parameters;
a ratio of the variance of the N signal quality parameters to a mean of the signal quality parameters;
a first time length and start and end time of a time period corresponding to a signal quality parameter greater than a first quality parameter threshold in the N signal quality parameters;
a second time length and start and end time of a time period corresponding to a signal quality parameter less than a second quality parameter threshold in the N signal quality parameters;
a ratio of the first time length to the measurement time range of the first satellite cell; and
a ratio of the second time length to the measurement time range of the first satellite cell.

Optionally, the signal quality parameter is one of the following: RSRP, an RSSI, RSRQ, and an SINR.

Optionally, the measurement configuration information further includes a measurement condition of a neighboring satellite cell, where
the measurement condition of the neighboring satellite cell includes at least one of the following:
a priority of a satellite cell in a satellite series other than a satellite series of the terminal is higher than a priority of a satellite cell in the satellite series of the terminal; and
the priority of the satellite cell in the satellite series other than the satellite series of the terminal is not higher than the priority of the satellite cell in the satellite series of the terminal, and a signal quality fluctuation of the satellite cell in the satellite series of the terminal is greater than a fourth fluctuation threshold, where
the satellite series of the terminal is a satellite series to which a serving satellite cell of the terminal belongs.

Optionally, the measurement configuration information further includes a satellite cell reselection condition, and the reselection condition includes at least one of the following:
in a preset time threshold, signal quality of the satellite cell in the satellite series other than the satellite series of the terminal is not greater than the fourth fluctuation threshold; and
in the preset time threshold, signal quality of the satellite cell in the satellite series other than the satellite series of the terminal is not higher than signal quality of the satellite cell in the satellite series of the terminal.

Optionally, the measurement configuration information further includes a series identifier of the first satellite series and a series identifier of the second satellite series.

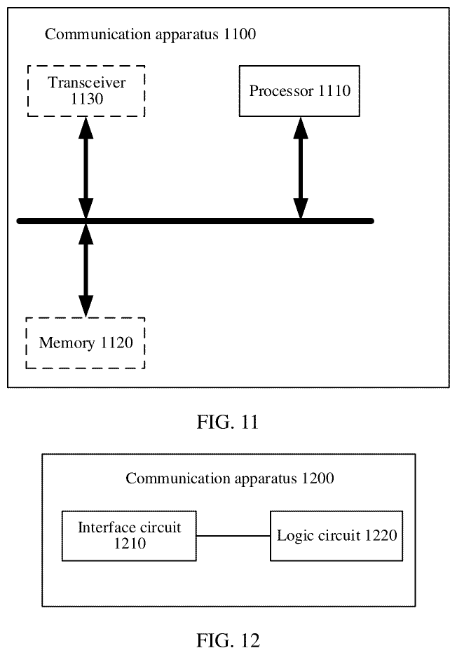

FIG. 11 shows a communication apparatus 1100 further provided in this application. The communication apparatus 1100 may be a chip or a chip system. The communication apparatus may be located in a device in any one of the foregoing method embodiments, for example, a satellite, a network device, or a terminal, to perform an action corresponding to the device.

Optionally, the chip system may include a chip, or may include a chip and another discrete device.

The communication apparatus 1100 includes a processor 1110.

The processor 1110 is configured to execute a computer program stored in a memory 1120, to implement actions of each device in any one of the foregoing method embodiments.

The communication apparatus 1100 may further include the memory 1120, configured to store the computer program.

Optionally, the memory 1120 is coupled to the processor 1110. The coupling is an indirect coupling or a communication connection between apparatuses, units, or modules, may be in an electrical form, a mechanical from, or another form, and is used for information exchange between the apparatuses, the units, or the modules. Optionally, the memory 1120 and the processor 1110 are integrated together.

There may be one or more processors 1110 and one or more memories 1120. This is not limited.

Optionally, in actual application, the communication apparatus 1100 may include or may not include a transceiver 1130. A dashed box is used as an example in the figure. The communication apparatus 1100 may exchange information with another device through the transceiver 1130. The transceiver 1130 may be a circuit, a bus, a transceiver, or any other apparatus that may be configured to exchange information.

In a possible implementation, the communication apparatus 1100 may be a first satellite or a terrestrial device in the foregoing method embodiments.

A specific connection medium between the transceiver 1130, the processor 1110, and the memory 1120 is not limited in embodiments of this application. In embodiments of this application, the memory 1120, the processor 1110, and the transceiver 1130 are connected through a bus in FIG. 11. The bus is represented by a bold line in FIG. 11. A manner of connection between other components is merely an example for description, and is not limited thereto. The bus may be classified into an address bus, a data bus, a control bus, and the like. For ease of representation, only one bold line is used to represent the bus in FIG. 11, but this does not mean that there is only one bus or only one type of bus. In embodiments of this application, the processor may be a general-purpose processor, a digital signal processor, an application-specific integrated circuit, a field programmable gate array or another programmable logic device, a discrete gate or transistor logic device, or a discrete hardware component, and may implement or execute the methods, steps, and logical block diagrams disclosed in embodiments of this application. The general-purpose processor may be a microprocessor or any conventional processor or the like. The steps of the method disclosed with reference to embodiments of this application may be directly performed by a hardware processor, or may be performed by using a combination of hardware in the processor and a software module.

In embodiments of this application, the memory may be a non-volatile memory, for example, a hard disk drive (HDD) or a solid-state drive (SSD), or may be a volatile memory, for example, a random-access memory (RAM). Alternatively, the memory may be any other medium that can be used to carry or store expected program code in a form of instructions or a data structure and that is accessible by a computer, but is not limited thereto. Alternatively, the memory in embodiments of this application may be a circuit or any other apparatus that can implement a storage function, and is configured to store a computer program, program instructions, and/or data.

Based on the foregoing embodiments, refer to FIG. 12. An embodiment of this application further provides another communication apparatus 1200, including an interface circuit 1210 and a logic circuit 1220. The interface circuit 1210 may be understood as an input/output interface, and may be configured to perform receiving and sending steps of each device in any one of the foregoing method embodiments. The logic circuit 1220 may be configured to run code or instructions to perform the method performed by each device in any one of the foregoing embodiments.

Based on the foregoing embodiments, an embodiment of this application further provides a computer-readable storage medium. The computer-readable storage medium stores instructions, and when the instructions are executed, the method performed by each device in any one of the foregoing method embodiments are implemented. The computer-readable storage medium may include any medium that can store program code, such as a USB flash drive, a removable hard disk drive, a read-only memory, a random-access memory, a magnetic disk, or an optical disc.

Based on the foregoing embodiments, an embodiment of this application provides a communication system. The communication system includes the satellite, the terminal, and the network device in any one of the foregoing method embodiments, and may be configured to perform the method performed by each device in any one of the foregoing method embodiments.

A person skilled in the art should understand that embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a magnetic disk memory, a compact disc read-only memory (CD-ROM), an optical memory, and the like) that include computer-usable program code.

This application is described with reference to the flowcharts and/or the block diagrams of the method, the apparatus (system), and the computer program product according to this application. It should be understood that computer program instructions may be used to implement each procedure and/or each block in the flowcharts and/or the block diagrams and a combination of a procedure and/or a block in the flowcharts and/or the block diagrams. These computer program instructions may be provided for a general-purpose computer, a dedicated computer, an embedded processor, or a processor of another programmable data processing apparatus to generate a machine, so that an apparatus for implementing a specific function in one or more procedures in the flowcharts and/or in one or more blocks in the block diagrams is generated by using the instructions executed by a computer or the processor of any other programmable data processing apparatus.

These computer program instructions may alternatively be stored in a computer-readable memory that can indicate a computer or another programmable data processing apparatus to work in a specific manner, so that an artifact that includes an instruction apparatus is generated by using the instructions stored in the computer-readable memory. The instruction apparatus implements a specific function in one or more procedures in the flowcharts and/or in one or more blocks in the block diagrams.

These computer program instructions may alternatively be loaded onto a computer or another programmable data processing apparatus, so that a series of operation steps are performed on the computer or the another programmable apparatus to generate computer-implemented processing. Therefore, steps for implementing a specific function in one or more procedures in the flowcharts and/or in one or more blocks in the block diagrams are provided by using the instructions executed on the computer or the another programmable apparatus.

1. A signal measurement method, comprising:
obtaining, by a terminal, measurement configuration information including information about at least one satellite cell and a measurement time range of the at least one satellite cell, wherein the at least one satellite cell comprises a first satellite cell, a measurement time range of the first satellite cell is all or a part of a time length in which a coverage area of the first satellite cell is in a first area, and the terminal is located in the first area; and
obtaining a metric by measuring, by the terminal, a signal of the at least one satellite cell in the first area based on the measurement configuration information, wherein the metric indicates a signal quality fluctuation of the at least one satellite cell in the measurement time range.

2. The method according to claim 1, wherein satellites, corresponding to the at least one satellite cell, are included in a first satellite series and a second satellite series, and satellites in a same satellite series have a same orbit or have a same earth projection track.

3. The method according to claim 2, wherein satellite cells of different satellites, in the same satellite series, have a different measurement start and end time.

4. The method according to claim 1, wherein the terminal obtains N signal quality parameters through measurement in the measurement time range of the first satellite cell, and a metric of the first satellite cell comprises at least one of:
a signal quality parameter of a worst signal in the N signal quality parameters;
a variance of the N signal quality parameters;
a ratio of the variance of the N signal quality parameters to a mean of the signal quality parameters;
a first time length and start and end time of a time period corresponding to a signal quality parameter greater than a first quality parameter threshold in the N signal quality parameters;
a second time length and start and end time of a time period corresponding to a signal quality parameter less than a second quality parameter threshold in the N signal quality parameters;
a ratio of the first time length to the measurement time range of the first satellite cell; or
a ratio of the second time length to the measurement time range of the first satellite cell.

5. The method according to claim 4, wherein the signal quality parameter is one of: reference signal received power (RSRP), a received signal strength indicator (RSSI), reference signal received quality (RSRQ), and a signal-to-interference-plus-noise ratio (SINR).

6. The method according to claim 1, wherein the measurement configuration information further comprises a report configuration, and the report configuration comprises:
report content configuration information indicating a type of the metric comprised in a measurement report, and
a trigger event indicating a trigger condition for reporting the measurement report.

7. The method according to claim 6, wherein the trigger event comprises at least one of:
a first trigger event indicating to report the measurement report when a signal quality fluctuation of a satellite cell in a satellite series of the terminal is greater than a first fluctuation threshold,
a second trigger event indicating to report the measurement report when the signal quality fluctuation of the satellite cell in the satellite series of the terminal is less than a second fluctuation threshold,
a third trigger event indicating to report the measurement report when a signal quality fluctuation of a satellite cell in a satellite series other than the satellite series of the terminal is greater than a third fluctuation threshold, and
a fourth trigger event indicating to report the measurement report when the signal quality fluctuation of the satellite cell in the satellite series other than the satellite series of the terminal is greater than a signal quality fluctuation of a satellite cell in the first satellite series, wherein
the satellite series of the terminal is a satellite series to which a serving satellite cell of the terminal belongs.

8. The method according to claim 1, wherein the measurement configuration information further comprises a measurement condition of a neighboring satellite cell, and the measurement condition of the neighboring satellite cell comprises at least one of:
a priority of a satellite cell in a satellite series other than a satellite series of the terminal is higher than a priority of a satellite cell in the satellite series of the terminal, and
the priority of the satellite cell in the satellite series other than the satellite series of the terminal is not higher than the priority of the satellite cell in the satellite series of the terminal, and a signal quality fluctuation of the satellite cell in the satellite series of the terminal is greater than a fourth fluctuation threshold, wherein
the satellite series of the terminal is a satellite series to which a serving satellite cell of the terminal belongs.

9. The method according to claim 8, wherein the measurement configuration information further comprises a satellite cell reselection condition, and the satellite cell reselection condition comprises at least one of:
in a preset time threshold, signal quality of the satellite cell in the satellite series other than the satellite series of the terminal is not greater than the fourth fluctuation threshold, and
in the preset time threshold, signal quality of the satellite cell in the satellite series other than the satellite series of the terminal is not higher than signal quality of the satellite cell in the satellite series of the terminal.

10. The method according to claim 2, wherein the measurement configuration information further comprises:
a series identifier of the first satellite series, and a series identifier of the second satellite series.

11. A communication apparatus, comprising:
at least one processor operatively coupled to a memory; and
the at least one processor is configured to execute a computer program or instructions stored in the memory and cause the communication apparatus to:
obtain measurement configuration information including information about at least one satellite cell and a measurement time range of the at least one satellite cell, wherein the at least one satellite cell comprises a first satellite cell, a measurement time range of the first satellite cell is all or a part of a time length in which a coverage area of the first satellite cell is in a first area, and a terminal is located in the first area; and
obtain a metric by measuring a signal of the at least one satellite cell in the first area based on the measurement configuration information, wherein the metric indicates a signal quality fluctuation of the at least one satellite cell in the measurement time range.

12. The apparatus according to claim 11, wherein satellites, corresponding to the at least one satellite cell, are included in a first satellite series and a second satellite series, and satellites in a same satellite series have a same orbit or have a same earth projection track.

13. The apparatus according to claim 12, wherein satellite cells of different satellites, in the same satellite series, have different measurement start and end time.

14. The apparatus according to claim 11, wherein the terminal obtains N signal quality parameters through measurement in the measurement time range of the first satellite cell, and a metric of the first satellite cell comprises at least one of:
a signal quality parameter of a worst signal in the N signal quality parameters;
a variance of the N signal quality parameters;
a ratio of the variance of the N signal quality parameters to a mean of the signal quality parameters;
a first time length and start and end time of a time period corresponding to a signal quality parameter greater than a first quality parameter threshold in the N signal quality parameters;
a second time length and start and end time of a time period corresponding to a signal quality parameter less than a second quality parameter threshold in the N signal quality parameters;
a ratio of the first time length to the measurement time range of the first satellite cell; or
a ratio of the second time length to the measurement time range of the first satellite cell.

15. The apparatus according to claim 14, wherein the signal quality parameter is one of: reference signal received power (RSRP), a received signal strength indicator (RSSI), reference signal received quality (RSRQ), and a signal-to-interference-plus-noise ratio (SINR).

16. The apparatus according to claim 11, wherein the measurement configuration information further comprises a report configuration, and the report configuration comprises:
report content configuration information indicating a type of the metric comprised in a measurement report, and
a trigger event indicating a trigger condition for reporting the measurement report.

17. The apparatus according to claim 16, wherein the trigger event comprises at least one of:
a first trigger event indicating to report the measurement report when a signal quality fluctuation of a satellite cell in a satellite series of the terminal is greater than a first fluctuation threshold,
a second trigger event indicating to report the measurement report when the signal quality fluctuation of the satellite cell in the satellite series of the terminal is less than a second fluctuation threshold,
a third trigger event indicating to report the measurement report when a signal quality fluctuation of a satellite cell in a satellite series other than the satellite series of the terminal is greater than a third fluctuation threshold, and
a fourth trigger event indicating to report the measurement report when the signal quality fluctuation of the satellite cell in the satellite series other than the satellite series of the terminal is greater than a signal quality fluctuation of a satellite cell in the first satellite series, wherein
the satellite series of the terminal is a satellite series to which a serving satellite cell of the terminal belongs.

18. The apparatus according to claim 11, wherein the measurement configuration information further comprises a measurement condition of a neighboring satellite cell, and the measurement condition of the neighboring satellite cell comprises at least one of:
a priority of a satellite cell in a satellite series other than a satellite series of the terminal is higher than a priority of a satellite cell in the satellite series of the terminal, and
the priority of the satellite cell in the satellite series other than the satellite series of the terminal is not higher than the priority of the satellite cell in the satellite series of the terminal, and a signal quality fluctuation of the satellite cell in the satellite series of the terminal is greater than a fourth fluctuation threshold, wherein
the satellite series of the terminal is a satellite series to which a serving satellite cell of the terminal belongs.

19. The apparatus according to claim 18, wherein the measurement configuration information further comprises a satellite cell reselection condition, and the satellite cell reselection condition comprises at least one of:
in a preset time threshold, signal quality of the satellite cell in the satellite series other than the satellite series of the terminal is not greater than the fourth fluctuation threshold, and
in the preset time threshold, signal quality of the satellite cell in the satellite series other than the satellite series of the terminal is not higher than signal quality of the satellite cell in the satellite series of the terminal.

20. The apparatus according to claim 12, wherein the measurement configuration information further comprises:
a series identifier of the first satellite series, and a series identifier of the second satellite series.
